(19) United States
(12) Patent Application Publication
(10) Pub. No.: US 2026/0279177 A1
(43) Pub. Date: Sep. 17, 2026

(54) EARLY STAGE FIRE DETECTION USING INFRARED TECHNOLOGY

(71) Applicant: Tyco Fire Products LP, Cranston, RI (US)

(72) Inventors: Luke Charles Giwojna, Coleman, WI (US); Daniel Cazares, Marinette, WI (US); Sean S. Troutt, Stephenson, MI (US); David Strobel, Marinette, WI (US)

(73) Assignee: Tyco Fire Products LP, Cranston, RI (US)

(21) Appl. No.: 19/469,222

(22) PCT Filed: Jun. 25, 2024
(86) PCT No.: PCT/IB2024/056169

§ 371 Date: Sep. 25, 2025

Related U.S. Application Data
(60) Provisional application No. 63/510,979, filed on Jun. 29, 2023.

(51) Int. Cl. G08B 17/06; A62C 3/16; A62C 35/11; G08B 17/12

(52) U.S. Cl. CPC G08B 17/06; A62C 3/16; A62C 35/11; G08B 17/12

(57) ABSTRACT

A thermal runaway detection and prevention system. The system comprises one or more thermopiles configured to measure one or more thermal characteristics of a monitored area, and a controller having one or more processors and a memory storing instruction that, when executed by the one or more processors, cause the one or more processors to perform operations. The operations may comprise identifying the one or more thermopiles in the monitored area, and receiving, from the one or more thermopiles, thermal signals relating to one or more measured thermal characteristics of the monitored area. The operations may also comprise detecting, based on the thermal signals, a potential thermal runaway event, and initiating a control decision in response to detecting the potential thermal runaway event.

### CROSS-REFERENCE TO RELATED PATENT APPLICATION

This application claims the benefit of and priority to U.S. Provisional Application No. 63/510,979, filed on Jun. 29, 2023, the entire disclosure of which is hereby incorporated by reference herein.

### BACKGROUND

The present disclosure relates generally to fire suppression systems. More specifically, the present disclosure relates to fire suppression systems for batteries. Modern battery technologies, such as lithium-ion batteries, are desirable for use in many energy storage applications due to their high energy density. However, the materials used in such batteries can be quite flammable and can produce flammable gases (e.g., when overheating). Once the batteries ignite, the resultant fires can be difficult to suppress due to their high temperatures, and the fires can travel quickly between adjacent battery cells. The cells of the batteries are often contained within a sealed housing, making it difficult for external sources to detect potential hazardous conditions.

### SUMMARY

One implementation of the present disclosure is a thermal runaway detection and prevention system. The system may include one or more thermopiles configured to measure one or more thermal characteristics of a monitored area, and a controller having one or more processors and a memory storing instruction that, when executed by the one or more processors, cause the one or more processors to perform operations. The operations may comprise identifying the one or more thermopiles in the monitored area, and receiving, from the one or more thermopiles, thermal signals relating to one or more measured thermal characteristics of the monitored area. The operations may also comprise detecting, based on the thermal signals, a potential thermal runaway event, and initiating a control decision in response to detecting the potential thermal runaway event.

Another implementation of the present disclosure is a thermal runaway detection and prevention system. The system may include an infrared sensor configured to measure one or more thermal characteristics of a monitored area, and a controller having one or more processors and a memory storing instruction that, when executed by the one or more processors, cause the one or more processors to perform operations. The operations may comprise identifying one or more zones in the monitored area, and receiving, from the infrared sensor, thermal signals relating to one or more measured thermal characteristics, wherein the one or more measured thermal characteristics relate to one or more identified zones. The operations may also comprise detecting, based on the thermal signals, a potential thermal runaway event, and initiating a control decision in response to detecting the potential thermal runaway event.

Another implementation of the present disclosure relates to a method for detecting and mitigating a potential thermal runaway event. The method may include identifying, via a controller, one or more thermopiles in a monitored area, and receiving, from the one or more thermopiles in the monitored area, thermal signals relating to one or more measured thermal characteristics of the monitored area. The method may also include detecting, via the controller and based on the thermal signals, the potential thermal runaway event, and initiating, via the controller, a control decision in response to detecting the potential thermal runaway event.

Another implementation of the present disclosure relates to a method for detecting and mitigating a potential thermal runaway event. The method may include identifying, via a controller, one or more zones in a monitored area, and receiving, from an infrared sensor, thermal signals relating to one or more measured thermal characteristics, wherein the one or more measured thermal characteristics relate to one or more identified zones. The method may also include detecting, via the controller and based on the thermal signals, the potential thermal runaway event, and initiating, via the controller, a control decision in response to detecting the potential thermal runaway event.

### BRIEF DESCRIPTION OF THE DRAWINGS

FIG. 1 is a schematic of a fire detection and mitigation system, according to some embodiments.

FIG. 2 is a schematic of a battery system, according to some embodiments.

FIG. 3 is an illustration of a fire detection and prevention system in a monitored area, according to some embodiments.

FIG. 4 is another illustration of the fire detection and prevention system of FIG. 3 in a monitored area, according to some embodiments.

FIG. 5 is a schematic of the fire detection and prevention system of FIG. 3 in a monitored area, according to some embodiments.

FIG. 6 is another schematic of the fire detection and prevention system of FIG. 3 in a monitored area, according to some embodiments.

FIG. 7 is a block diagram of the controller of FIG. 3, according to some embodiments.

FIG. 8 is a flow diagram of a process for a fire detection and prevention system, according to some embodiments.

FIG. 9 is another flow diagram of a process for a fire detection and prevention system, according to some embodiments.

### DETAILED DESCRIPTION

Before turning to the figures, which illustrate the embodiments in detail, it should be understood that the present disclosure is not limited to the details or methodology set forth in the description or illustrated in the figures. It should also be understood that the terminology used herein is for the purpose of description only and should not be regarded as limiting.

### Overview

Referring generally to the FIGURES, a fire detection and suppression system for preventing, eliminating, and/or mitigating a failure or thermal runaway event is shown, according to an embodiment. The system may include one or more thermopiles configured to monitor (e.g., measure, determine, analyze, etc.) a thermal characteristic of a monitored area (e.g., an internal housing of a battery pack, one or more components of a battery pack, including a battery cell, a battery module, and/or a subpack, etc.). The system may include a sensor (e.g., infrared temperature sensor, a high-speed infrared camera, an infrared grid sensor, one or more thermopiles, etc.) configured to monitor (e.g., measure, determine, analyze, etc.) one or more thermal characteristics of a monitored area (e.g., a room of a storage facility, an internal housing of a battery pack, etc.). The thermal characteristics may include, for example, radiant heat, thermal radiation, infrared thermal radiation, temperature, a temperature gradient, or another suitable thermal characteristic.

The system also includes a controller having one or more processors and a memory storing instruction that, when executed by the one or more processors, cause the one or more processors to perform operations. The operations may comprise identifying the one or more thermopiles in the monitored area. In some embodiments, the controller identifies the thermopiles based on one or more pieces of information (e.g., based on user input, hardcoded rules, learned thermal characteristic readings, configuration data, one or more inputs, including monitored area layout, component configurations, etc.). The operations also comprise receiving, from the one or more thermopiles, thermal signals relating to the monitored area, and detecting, based on the thermal signals, a potential thermal runaway event. In some embodiments, the controller detects a potential thermal runaway event based on a comparison of the received thermal signals to a threshold thermal condition (e.g., a maximum radiant temperature or thermal radiation measurement at a thermopile, a maximum deviation in a measured thermal radiation at a thermopile, a maximum radiant temperature or thermal radiation measurement across multiple thermopiles, an average radiant temperature or thermal radiation measurement across one or more thermopiles exceeding a certain threshold, etc.). The operations further include initiating a control decision in response to detecting the potential thermal runaway event. In some embodiments, initiating a control decision includes communicating an indicator to a device (e.g., an alert, alarm, message, instructions, etc.) or a control signal to a device (e.g., activation signal, control signal, deactivation signal, etc. to a suppression system).

In some embodiments, the controller is also configured to identify one or more zones in the monitored area. In some embodiments, the controller identifies, detects, or creates the zones (e.g., based on user input, hardcoded rules, learned thermal readings or data, one or more inputs, including monitored area layout, component configurations, etc.). The operations also comprise receiving, from the sensor (e.g., infrared sensor, infrared grid sensor, etc.), thermal signals relating to the one or more identified zones, and detecting, based on the thermal signals, a potential thermal runaway event.

In some embodiments, the controller can receive thermal signals relating to a monitored area from the sensor or sensors (e.g., infrared sensor and/or the one or more thermopiles). For example, the controller may be configured to receive, from the sensor, thermal signals relating to one or more identified zones. In some embodiments, the controller can detect, based on the thermal signals, a potential thermal runaway event (e.g., via a comparison of the received thermal signals to threshold conditions). In response to detecting a potential thermal runaway event (e.g., via the temperatures signals received from the temperature sensor), the controller can receive, from the one or more thermopiles, thermal signals relating to a thermal characteristic associated with the monitored area (e.g., the one or more thermopiles). For example, in response to the controller detecting a potential thermal runaway event at an identified zone, the controller may be configured to receive thermal signals from a set of one or more thermopiles located within the identified zones. The controller may analyze the thermal signals from the one or more thermopiles (e.g., compare the signals to threshold conditions, etc.), for example to identify an area within the identified zone experiencing a potential thermal runaway event, confirm and/or deny detection of a thermal runaway event, and/or detect additional or fewer potential thermal runaway events. In response to detecting a thermal runaway event, the controller may further initiate one or more control decisions.

Advantageously, the sensor or sensors (e.g., infrared sensor, one or more thermopiles, or a combination thereof) of the fire detection and prevention system as shown in the FIGURES, and described in the accompanying description, can be used individually and/or in combination to facilitate early detection of a potential failure or thermal runaway event before it occurs (e.g., within a battery pack, within a storage facility, etc.).

### Fire Suppression System

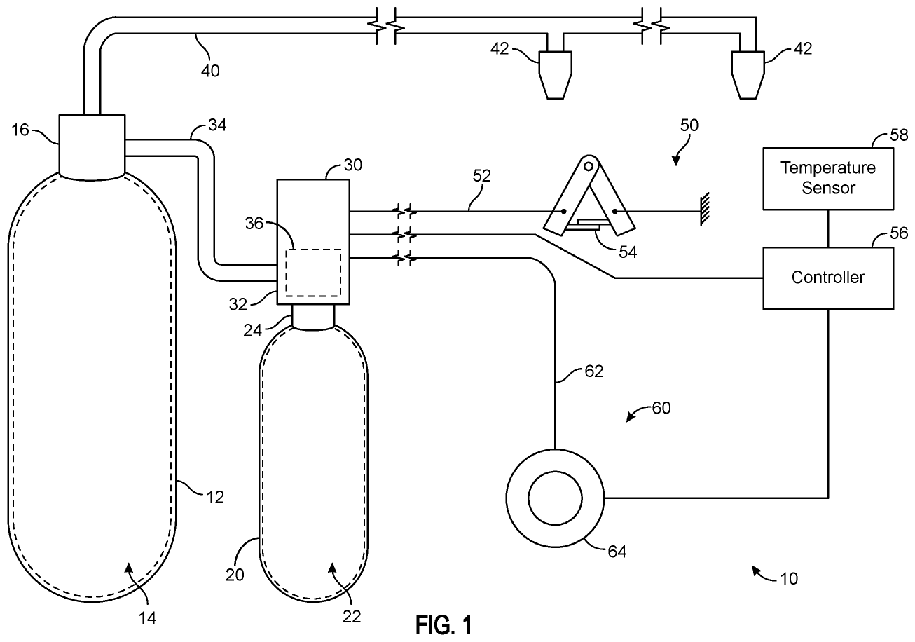

Referring to FIG. 1, a fire detection, fire prevention, fire mitigation, or fire suppression system, shown as system 10, is shown according to an embodiment. In one embodiment, the system 10 is a chemical fire prevention, mitigation, or suppression system. The system 10 can detect, mitigate, and/or prevent a failure or thermal runaway event. The system 10 may also be configured to dispense or distribute a fire suppressant agent onto and/or nearby a fire, for example to suppress or extinguish the fire and prevent the fire from spreading. The system 10 can be used alone or in combination with other types of fire suppression systems (e.g., a building sprinkler system, a handheld fire extinguisher, etc.). In some embodiments, multiple systems 10 are used in combination with one another to cover a larger area (e.g., each in different rooms of a building).

The system 10 can be used in a variety of different applications. Different applications can require different types of fire suppressant agent and different levels of mobility. The system 10 is usable with a variety of different fire suppressant agents, such as powders, liquids, foams, or other fluid or flowable materials. The system 10 can be used in a variety of stationary applications. By way of example, the system 10 is usable in a room or storage facility (e.g., battery storage facilities for chemical fires, etc.), within a battery pack itself (e.g., for chemical fires, etc.), in data centers (e.g., for electronics fires, etc.), at filling stations (e.g., for gasoline or propane fires, etc.), in kitchens (e.g., for oil or grease fires, etc.), in libraries, or in other stationary applications. Alternatively, the system 10 can be used in a variety of mobile applications. By way of example, the system 10 can be incorporated into land-based vehicles (e.g., racing vehicles, forestry vehicles, construction vehicles, agricultural vehicles, mining vehicles, passenger vehicles, refuse vehicles, etc.), airborne vehicles (e.g., jets, planes, helicopters, etc.), or aquatic vehicles, (e.g., ships, submarines, etc.).

Referring still to FIG. 1, the system 10 includes a fire suppressant tank 12 (e.g., a vessel, container, vat, drum, tank, canister, cartridge, or can, etc.). The fire suppressant tank 12 defines an internal volume 14 filled (e.g., partially, completely, etc.) with a fire suppressant agent. In some embodiments, the fire suppressant agent is normally not pressurized (e.g., is near atmospheric pressure). In other embodiments, the fire suppressant agent is pressurized (e.g., above atmospheric pressure). The fire suppressant tank 12 includes an exchange section, shown as neck 16. The neck 16 permits the flow of expellant gas into the internal volume 14 and the flow of fire suppressant agent out of the internal volume 14 so that the fire suppressant agent can be supplied to mitigate a failure or thermal runaway event and/or a fire.

The system 10 further includes a cartridge 20 (e.g., a vessel, container, vat, drum, tank, canister, cartridge, or can, etc.). The cartridge 20 defines an internal volume 22 configured to contain a volume of pressurized expellant gas. The expellant gas can be an inert gas. In some embodiments, the expellant gas is air, carbon dioxide, or nitrogen. The cartridge 20 includes an outlet section or outlet section, shown as neck 24. The neck 24 defines an outlet fluidly coupled to the internal volume 22. Accordingly, the expellant gas can leave the cartridge 20 through the neck 24. The cartridge 20 can be rechargeable or disposable after use. In some embodiments where the cartridge 20 is rechargeable, additional expellant gas can be supplied to the internal volume 22 through the neck 24.

The system 10 further includes a valve, puncture device, or activator assembly, shown as actuator 30. The actuator 30 includes an adapter, shown as receiver 32, which can receive the neck 24 of the cartridge 20. The neck 24 is selectively coupled to the receiver 32 (e.g., through a threaded connection, etc.). Decoupling the cartridge 20 from the actuator 30 facilitates removal and replacement of the cartridge 20 when the cartridge 20 is depleted. The actuator 30 is fluidly coupled to the neck 16 of the fire suppressant tank 12 through a conduit or pipe, shown as hose 34.

The actuator 30 includes an activation mechanism 36 configured to selectively fluidly couple the internal volume 22 to the neck 16. In some embodiments, the activation mechanism 36 includes one or more valves that selectively fluidly couple the internal volume 22 to the hose 34. The valves can be mechanically, electrically, manually, or otherwise actuated. The valves can be opened to release a portion of the expellant gas from the cartridge 20, closed, and then opened again to release another portion of expellant gas from the cartridge. In some such embodiments, the neck 24 includes a valve that selectively prevents the expellant gas from flowing through the neck 24. Such a valve can be manually operated (e.g., by a lever or knob on the outside of the cartridge 20, etc.) or can open automatically upon engagement of the neck 24 with the actuator 30. Such a valve facilitates removal of the cartridge 20 prior to depletion of the expellant gas. In other embodiments, the cartridge 20 is sealed, and the activation mechanism 36 includes a pin, knife, nail, or other sharp object that the actuator 30 forces into contact with the cartridge 20. This punctures the outer surface of the cartridge 20, fluidly coupling the internal volume 22 with the actuator 30. In some embodiments, the activation mechanism 36 punctures the cartridge 20 only when the actuator 30 is activated. In some such embodiments, the activation mechanism 36 omits any valves that control the flow of expellant gas to the hose 34. In other embodiments, the activation mechanism 36 automatically punctures the cartridge 20 as the neck 24 engages the actuator 30.

Once the actuator 30 is activated and the cartridge 20 is fluidly coupled to the hose 34, the expellant gas from the cartridge 20 flows freely through the neck 24, the actuator 30, and the hose 34 and into the neck 16. The expellant gas forces fire suppressant agent from the fire suppressant tank 12 out through the neck 16 and into a conduit or hose, shown as pipe 40. In one embodiment, the neck 16 directs the expellant gas from the hose 34 to a top section of the internal volume 14. The neck 16 defines an outlet (e.g., using a syphon tube, etc.) near the bottom of the fire suppressant tank 12. The pressure of the expellant gas at the top of the internal volume 14 forces the fire suppressant agent to exit through the outlet and into the pipe 40. In other embodiments, the expellant gas enters a bladder within the fire suppressant tank 12, and the bladder presses against the fire suppressant agent to force the fire suppressant agent out through the neck 16. In yet other embodiments, the pipe 40 and the hose 34 are coupled to the fire suppressant tank 12 at different locations. By way of example, the hose 34 can be coupled to the top of the fire suppressant tank 12, and the pipe 40 can be coupled to the bottom of the fire suppressant tank 12. In some embodiments, the fire suppressant tank 12 includes a burst disk that prevents the fire suppressant agent from flowing out through the neck 16 until the pressure within the internal volume 14 exceeds a threshold pressure. Once the pressure exceeds the threshold pressure, the burst disk ruptures, permitting the flow of fire suppressant agent. Alternatively, the fire suppressant tank 12 can include a valve, a puncture device, or another type of opening device or activator assembly that can fluidly couple the internal volume 14 to the pipe 40 in response to the pressure within the internal volume 14 exceeding the threshold pressure. Such an opening device can be configured to activate mechanically (e.g., the force of the pressure causes the opening device to activate, etc.) or the opening device may include a separate pressure sensor in communication with the internal volume 14 that causes the opening device to activate.

The pipe 40 is fluidly coupled to one or more outlets or sprayers, shown as nozzles 42. The fire suppressant agent flows through the pipe 40 and to the nozzles 42. The nozzles 42 each define one or more apertures, through which the fire suppressant agent exits, forming a spray of fire suppressant agent that covers a desired area. The sprays from the nozzles 42 can then mitigate or prevent a failure or thermal runaway event, or suppress or extinguish a fire within that area. The apertures of the nozzles 42 can be shaped to control the spray pattern of the fire suppressant agent leaving the nozzles 42. The nozzles 42 can be aimed such that the sprays cover specific points of interest (e.g., a specific piece of a battery pack in a storage facility, a specific battery cell within a battery pack, a specific component within an engine compartment of a vehicle, etc.). The nozzles 42 can be configured such that all of the nozzles 42 activate simultaneously, and/or the nozzles 42 can be configured such that only the nozzles 42 near the failure, thermal runaway event, and/or fire are activated.

The system 10 further includes a control system 50 that can detect, mitigate, and/or prevent a failure or thermal runaway event. The control system can further control the activation of the actuator 30. For example, the control system 50 may configured to monitor one or more conditions, and determine if those conditions are indicative of a potential failure or thermal runaway event, or a nearby fire. Upon detecting a potential failure or thermal runaway event, the control system 50 can implement one or more control decisions. For example, the control system 50 can communicate an alert, alarm, or other indicator (e.g., an alarm message, an error message, a notice, etc.) to a device, for example a remote device, indicating a potential failure or thermal runaway event has been detected. The control system 50 may further activate one or more components of the system 10 (e.g., the actuator 30), causing the fire suppressant agent to leave the nozzles 42, and mitigate or prevent the failure, thermal runaway event, and/or fire.

In some embodiments, the actuator 30 is controlled mechanically. As shown in FIG. 1, the control system 50 includes a mechanical system including a tensile member (e.g., a rope, a cable, etc.), shown as cable 52, that imparts a tensile force on the actuator 30. Without this tensile force, the actuator 30 will activate. The cable 52 is coupled to a fusible link 54, which is in turn coupled to a stationary object (e.g., a wall, the ground, etc.). The fusible link 54 includes two plates that are held together with a solder alloy having a predetermined melting point. A first plate is coupled to the cable 52, and a second plate is coupled to the stationary object. When the ambient temperature surrounding the fusible link 54 exceeds the melting point of the solder alloy, the solder melts, allowing the two plates to separate. This releases the tension on the cable 52, and the actuator 30 activates. In other embodiments, the control system 50 is another type of mechanical system that imparts a force on the actuator 30 to activate the actuator 30. The control system 50 can include linkages, motors, hydraulic or pneumatic components (e.g., pumps, compressors, valves, cylinders, hoses, etc.), or other types of mechanical components configured to activate the actuator 30. Some parts of the control system 50 (e.g., a compressor, hoses, valves, and other pneumatic components, etc.) can be shared with other parts of the system 100 (e.g., the manual activation system 60) or vice versa. The actuator 30 can additionally or alternatively be configured to activate in response to receiving a signal from the control system 50, as discussed below.

Referring still to FIG. 1, the control system 50 includes a controller 56. The controller 56 can include processing circuit having a processor and a memory (as discussed below), and the processor can execute one or more instructions stored within the memory to perform any of the functions described herein. For example, the controller 56 can monitor signals from one or more sensors, shown as temperature sensor 58 (e.g., a high-speed infrared camera, infrared grid sensor, etc.). The controller 56 can use the signals from the temperature sensor 58 to determine a temperature profile of one or more components within a monitored area. The controller 56 can use the signals from the temperature sensor 58 to determine a profile (e.g., temperature profile) of one or more components of a battery pack within a storage facility. The controller 56 may determine that the temperature profile of a part of or all of the battery pack exceeds a predetermined threshold criteria (e.g., gas emission, terminal temperature, external temperature, rate of temperature increase, etc.), which may indicate a potential failure or thermal runaway event. In response, the controller 56 may implement one or more control decisions, for example communicate an alert or alarm (e.g., warning message) to a remote device indicating a potential failure or thermal runaway event has been detected. In some embodiments, the controller 56 uses signals from the temperature sensor 58 to determine a temperature profile of a battery cell within a battery pack, for example to detect a potential failure or thermal runaway event within the battery pack (as discussed below).

The system 10 further includes a manual activation system 60 that can control the activation of the actuator 30. The manual activation system 60 can activate the actuator 30 in response to an input from an operator. The manual activation system 60 can be included instead of, or in addition to the control system 50. Both the control system 50 and the manual activation system 60 can activate the actuator 30 independently. By way of example, the control system 50 can activate the actuator 30 regardless of any input from the manual activation system 60, and vice versa.

As shown in FIG. 1, the manual activation system 60 includes a mechanical system including a tensile member (e.g., a rope, a cable, etc.), shown as cable 62, coupled to the actuator 30. The cable 62 is coupled to a human interface device (e.g., a button, a lever, a switch, a knob, a pull ring, etc.), shown as button 64. The button 64 can impart a tensile force on the cable 62 when pressed, and this tensile force is transferred to the actuator 30. The actuator 30 activates upon experiencing the tensile force. In other embodiments, the manual activation system 60 is another type of mechanical system that imparts a force on the actuator 30 to activate the actuator 30. The manual activation system 60 can include linkages, motors, hydraulic or pneumatic components (e.g., pumps, compressors, valves, cylinders, hoses, etc.), or other types of mechanical components configured to activate the actuator 30.

The actuator 30 can additionally, or alternatively, be configured to activate in response to receiving a signal from the manual activation system 60. As shown in FIG. 1, the button 64 is operably coupled to the controller 56. The controller 56 can be configured to monitor the status of a human interface device (e.g., engaged, disengaged, etc.). Upon determining that the human interface device is engaged, the controller provides a signal to activate the actuator 30. By way of example, the controller 56 can be configured to monitor a signal from the button 64 to determine if the button 64 is pressed. Upon detecting that the button 64 has been pressed, the controller 56 sends a signal to the actuator 30 to activate the actuator 30.

The control system 50 and the manual activation system 60 are shown to activate the actuator 30 both mechanically (e.g., though application of a tensile force through cables, through application of a pressurized liquid, through application of a pressurized gas, etc.) and electrically (e.g., by providing an electrical signal). It should be understood, however, that the control system 50 and/or the manual activation system 60 can be configured to activate the actuator 30 solely mechanically, solely electrically, or through some combination of both. By way of example, the control system 50 can omit the controller 56 and activate the actuator 30 based on the input from the fusible link 54. By way of another example, the control system 50 can omit the fusible link 54 and activate the actuator 30 using an input from the controller 56.

### Battery or Power System

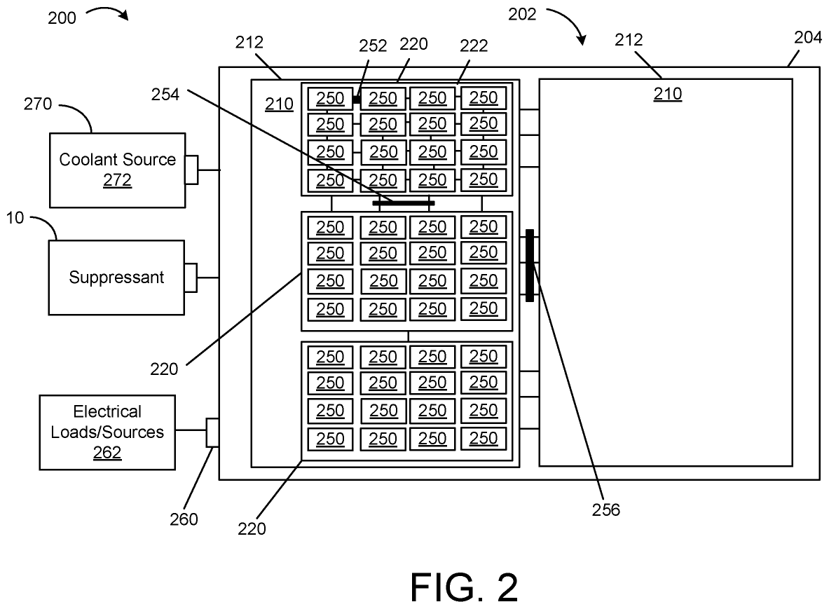

Referring to FIG. 2, a power system or battery system, shown as battery system 200, includes an energy storage device, energy storage assembly, battery assembly, power source, or electrical energy source, shown as battery pack 202, according to an embodiment. The battery pack 202 can store energy (e.g., chemically) and later discharge the stored energy as electrical energy to power one or more electrical loads (e.g., electric motors, resistive elements, lights, speakers, etc.). In some embodiments, the battery pack 202 is rechargeable using electrical energy (e.g., from an electrical grid, from a fuel cell, from a solar panel, from an electrical motor being driven as a generator, etc.).

The battery pack 202 includes a shell or housing, shown as pack housing 204, that defines a volume containing components of the battery pack 202 (e.g., the subpacks 210).

The pack housing 204 may seal the components of the battery pack 202 from the surrounding environment (e.g., limiting or preventing ingress of water or dust). The pack housing 204 may define one or more ports to facilitate transfer of electrical energy, coolant, fire suppressant, or other material into or out of the battery pack 202.

The battery pack 202 includes a series of battery portions or sections, shown as subpacks 210. By way of example, the battery pack 202 may include four subpacks 210. In other embodiments, the battery pack 202 includes more or fewer subpacks 210. Each subpack 210 can store a portion of the stored energy of the battery pack 202. Each subpack 210 includes a housing 212 containing components of the subpack 210 (e.g., the battery modules 220).

Each subpack 210 includes a series of battery portions or sections, shown as battery modules 220. By way of example, each subpack 210 may include eight battery modules 220. In other embodiments, each subpack 210 includes more or fewer battery modules 220. Each battery module 220 can store a portion of the stored energy of the corresponding subpack 210. Each battery module 220 includes a housing 222 containing components of the battery module 220 (e.g., the battery cells 250).

Each battery module 220 includes a series of battery portions or sections, shown as battery cells 250. By way of example, each battery module 220 may include hundreds of battery cells 250. In other embodiments, each battery module 220 includes more or fewer battery cells 250. Each battery cell 250 can store a portion of the energy stored by the corresponding battery module 220.

In some embodiments, the battery cells 250 are lithium-ion (i.e., Li-ion) battery cells. Each battery cell 250 may be configured to receive electrical energy, store the received energy chemically, and release the stored electrical energy. As shown in FIG. 2, the battery cells 250 are arranged in rows adjacent one another within the battery module 220, reducing empty space within the battery module 220 and reducing the overall size of the battery pack 202. The battery cells 250 may be cylindrical cells, prismatic cells, pouch cells, or another form factor of battery cells.

The battery cells 250 may be electrically coupled to one another within the battery pack 202. By way of example, in one arrangement (a) the battery cells 250 within each battery module 220 are electrically coupled to one another, (b) the battery modules 220 within each subpack 210 are electrically coupled to one another, and (c) the subpacks 210 are electrically coupled to one another (as shown in at least FIG. 2). The collective arrangement of battery cells 250, battery modules 220, and subpacks 210 is electrically coupled to a connector or port, shown as electrical port 260. The electrical port 260 electrically couples the battery cells 250 to one or more electrical sources and/or loads, shown as electrical loads/sources 262. The battery cells 250 may be discharged through the electrical port 260 to power the electrical loads/sources 262. The battery cells 250 may receive electrical energy through the electrical port 260 to charge the battery cells 250.

In some embodiments, one or more of the electrical couplings between (a) the battery cells 250 within each battery module 220, (b) the battery modules 220 within each subpack 210, and (c) the subpacks 210, and/or any combination thereof, include one or more thermocouples (not shown). For example, the electrical couplings can include one or more thermocouples, for example to measure a temperature at one or more of the battery cells 250, one or more of the battery modules 220, and/or one or more of the subpacks 210.

In other embodiments, at (a) the battery cells 250 within each battery module 220, (b) the battery modules 220 within each subpack 210, and (c) the subpacks 210, and/or any combination thereof, the battery pack 202 includes one or more thermopiles, shown as thermopiles 252, 254, 256. The thermopiles 252, 254, 256 may be configured to measure a local temperature characteristic (e.g., radiated heat, thermal radiation, infrared thermal radiation, a temperature gradient, etc.). For example, thermopile 252 can measure a temperature characteristic at battery cells 250, thermopile 254 can measure a temperature characteristic at battery modules 220, and/or thermopile 256 can measure a temperature characteristic at subpacks 210, etc. In an embodiment, thermopiles 252, 254, 256 can communicate one or more signals (e.g., electrical signal, etc.), representative of the measured temperature characteristic, to one or more remote devices (e.g., a controller), as discussed below. In other embodiments, thermopiles 252, 254, 256 can measure a temperature characteristic and/or communicate a temperature signal relating to a single battery cell 250, battery module 220, battery subpack 210, and/or any other suitable component of the battery pack 202.

In other embodiments, the thermopiles 252, 254, 256 are also configured to measure a temperature (e.g., current temperature, absolute temperature, temperature deviation or variance, etc.) at one or more of the battery cells 250, one or more of the battery modules 220, and/or one or more of the subpacks 210. The thermopiles 252, 254, 256 may be arranged or spaced in any suitable configuration around one or more components of the battery pack 202 (e.g., uniformly, spaced at predefined distances, having a staggered configuration, randomly, etc.). Advantageously, the thermopiles 252, 254, 256 can measure and/or communicate temperature characteristics (e.g., radiated heat, thermal radiation, infrared thermal radiation, a temperature gradient, etc.) on a more global scale (e.g., compared to individual thermocouple connections) to more easily, efficiently, and accurately measure temperature characteristics or profiles of one or more components of the battery pack 202 (e.g., battery cells 250, battery modules 220, and/or subpacks 210, etc.). In this regard, the thermopiles 252, 254, 256 may be configured to measure and/or communicate temperature characteristics (e.g., radiated heat, thermal radiation, etc.), which may be used to more efficiently detect and/or prevent a potential failure or thermal runaway event (e.g., within a battery pack 202).

The battery cells 250, the battery modules 220, and the subpacks 210 may be arranged in series/parallel to control the output voltage of the battery pack 202 at the electrical port 260 and the capacity of the battery pack 202 at that output voltage. Battery cells 250 may be arranged in series with one another to increase an output voltage of the battery pack 202. Battery cells 250 may be arranged in parallel with one another to increase the capacity (e.g., measured in amp-hours) of the battery pack 202. By way of example, the battery modules 220 within each subpack 210 may be connected to one another in series, forming a string. The subpacks 210 may be connected to one another in parallel, such that the strings are connected in parallel.

In other embodiments, the battery pack 202 is otherwise arranged. By way of example, the battery pack 202 may include more or fewer battery cells 250, battery modules 220, and/or subpacks 210. By way of another example, the battery cells 250, battery modules 220, and/or subpacks 210 may be arranged in rows, columns, helical patterns, or otherwise positioned within the pack housing 204. In some embodiments, the subpacks 210 are omitted, and the battery modules 220 are positioned directly within the battery pack 202.

In some embodiments, the battery system 200 includes a cooling subsystem, shown as cooling system 270. The cooling system 270 includes a coolant source 272 that can supply a flow of coolant to one or more conduits, or cooling channels. The coolant source 272 may include pumps, reservoirs, valves, and/or other components that facilitate handling the coolant. The coolant source 272 may also include one or more radiators or heat exchangers that facilitate discharging thermal energy from the coolant (e.g., to the surrounding atmosphere).

In some embodiments, the cooling channels pass into the pack housing 204 at an inlet and exit the pack housing 204 at an outlet. The cooling channels can pass through the housings 232 of the subpacks 210 and the housings 242 of the battery modules 220 and pass adjacent (e.g., in contact with) the battery cells 250. In some embodiments, at least a portion of the cooling channels is contained within and/or pass along the walls of the pack housing 204, the housings 232, and/or housings 242. The cooling channels can facilitate conduction between the coolant and the battery cells 250, such that thermal energy generated by the battery cells 250 (e.g., when charging or discharging electrical energy) is transferred to the coolant. The flow of coolant then transfers the thermal energy back to the coolant source 272 to be discharged. Accordingly, the cooling system 270 facilitates maintaining a consistent, low operating temperature of the battery pack 202.

Referring still to FIG. 2, the battery system 200 further includes a fire detection, fire prevention, fire mitigation, or fire suppression system. For example, the fire detection, prevention, mitigation, or suppression system may be the system 10 of FIG. 1. As discussed above, the system 10 can detect a potential failure or thermal runaway event, and/or address fires within the battery pack 202 by supplying a fire suppressant. The suppressant may suppress active fires (e.g., preventing the fire from accessing oxygen). The suppressant may also cool the battery cells 250, preventing later ignition or re-ignition of the battery cells 250. The system 10 may advantageously prevent, address, or otherwise mitigate thermal runaway of the battery cells 250.

As discussed above, the system 10 includes a container of suppressant (e.g., a tank, a vessel, a cartridge, a reservoir, etc.) or fire suppressant source. The suppressant may include a gas (e.g., an inert gas, nitrogen, etc.), a liquid suppressant (e.g., water), a gel suppressant, a dry chemical suppressant, another type of suppressant, or combinations thereof. Further, the system 10 may include an actuator, which can initiate a transfer (e.g., a flow) of fire suppressant from the suppressant container to the battery pack 202. By way of example, the activator may include a valve or seal puncture actuator that selectively permits suppressant to flow out of the suppressant container. By way of another example, the activator may include a pump that can impel the flow of suppressant. Further, the system 10 may include one or more conduits (e.g., pipes, hoses, tubes, etc.), or a distribution network, that can transfer suppressant from the suppressant container to the battery pack 202. The distribution network may transfer the suppressant the exterior of the battery pack 202. By way of example, the distribution network may provide the suppressant to an outlet (e.g., nozzle), that is positioned to direct suppressant to the exterior of the pack housing 204. Additionally or alternatively, the distribution network may transfer the suppressant to an interior of the battery pack 202 (e.g., inside the pack housing 204, inside the housing 212, inside the housing 222, etc.).

### Failure or Thermal Runaway Detection and Alert System

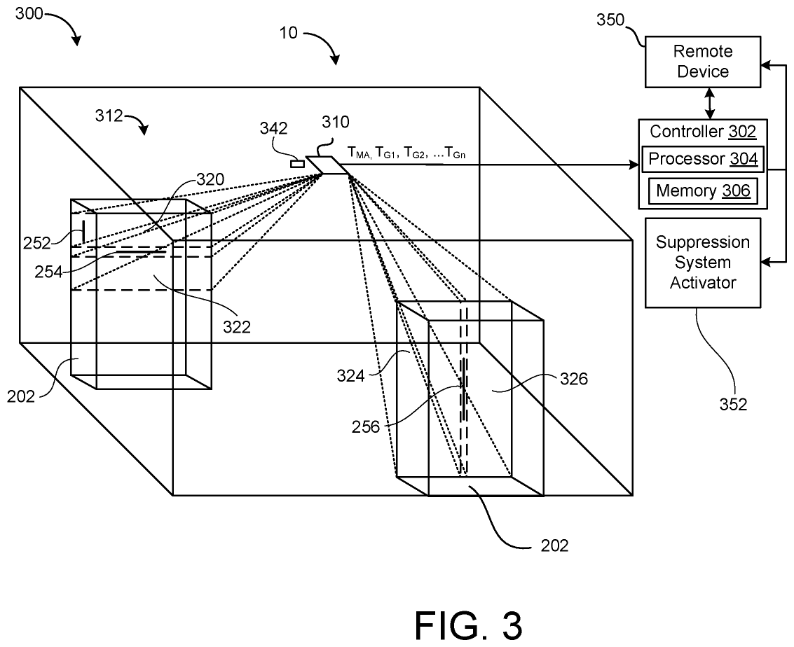

Referring now to FIGS. 3-6, a fire detection, prevention, mitigation, and/or suppression system, or system 300, is shown according to an embodiment. In some embodiments, the system 300 is or includes the control system 50. The system 300 can detect a potential failure or thermal runaway event (e.g., a maximum thermal radiation condition, a deviation in a thermal radiation condition, a maximum temperature condition, etc.) in a monitored area. In some embodiments, the system can implement one or more control decisions in response to detecting the potential failure or thermal runaway event. For example, the system 300 may be configured to detect a potential failure or thermal runaway event of a battery pack 202 (e.g., a battery module 220, a battery cell 250, etc.), and/or communicate an alert or alarm (e.g., a message, an alert message, etc.) indicating the detection of the potential failure or thermal runaway event. In some embodiments, the system 300 is also configured to activate one or more components of the system 10 in response to detecting a potential failure or thermal runaway event. For example, the system 300 may be configured to activate system 10 such that the expellant gas exits internal volume 22 of cartridge 20 through neck 24, and the fire suppressant exits internal volume 14 of fire suppressant tank 12 through neck 16 into the monitored area. In some embodiments, the system 300 includes all of the functionality of control system 50. In this regard, in some embodiments the system 300 replaces control system 50.

As shown in FIGS. 3-6, the system 300 includes a controller 302 including processing circuit, having a processor 304 and a memory 306. The processor 304 may execute one or more instructions stored within the memory 306 to perform any of the functions described herein. For example, the controller 302 can monitor signals from one or more sensors or other components (e.g., a thermopile or group of thermopiles, a high-speed infrared camera, an infrared grid sensor, etc.), and/or determine a profile of one or more components within a monitored area. For example, the controller 302 can monitor signals from one or more sensors, and determine a temperature profile of a component of a battery pack 202 within a storage facility, as discussed below. In other embodiments, the controller 302 monitors signals from one or more sensors, and determines a temperature profile of a battery cell 250 within a battery pack 202, as discussed below. The controller 302 can determine whether the temperature profile exceeds a predetermined threshold characteristic (e.g., a maximum thermal radiation condition, a deviation in a thermal radiation condition, threshold temperature condition, terminal temperature, external temperature, rate of temperature change, gas emission characteristics, etc.), which may be indicative of a potential failure or thermal runaway event. The controller 302 may further implement one or more control decisions (e.g., communicate an alert or alarm, activate a component of the system 10, etc.), as discussed below. In some embodiments, the controller 302 is the controller 56 of FIG. 1.

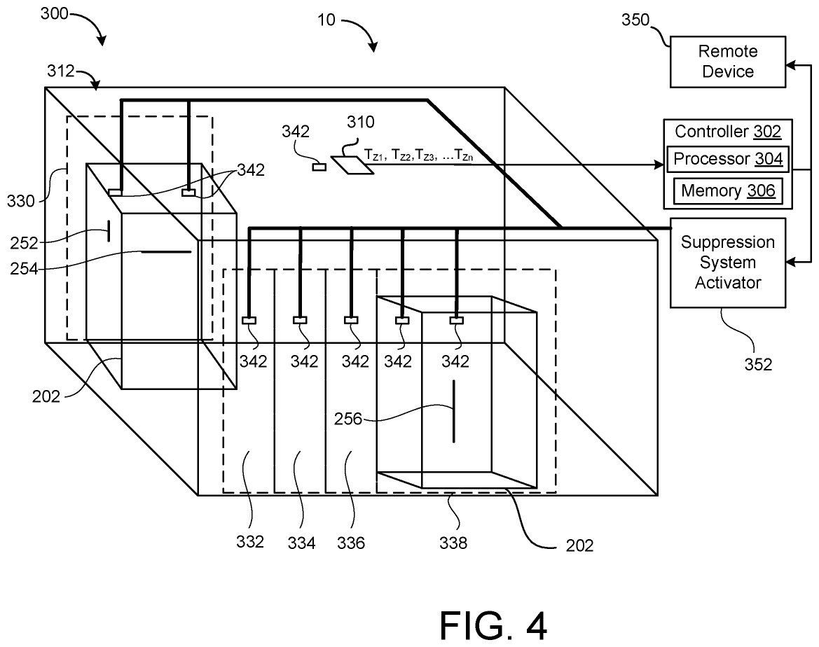

As shown in FIGS. 3-4, the system 300 also includes one or more sensors, shown as sensor 310. The sensor 310 can be a high-speed infrared camera. In some embodiments, the sensor 310 is an infrared grid sensor with a viewing field or grid composed of multiple pixels. The sensor 310 (e.g., high-speed infrared camera, infrared grid sensor, etc.) can detect (e.g., identify, receive, determine, etc.) signals with a predefined characteristic. For example, the sensor 310 may be configured to detect infrared signals. In some embodiments, the sensor 310 can detect infrared signals (e.g., infrared radiation, etc.) within a predetermined wavelength range, for example between 0.75 and 1.4 micrometers, 1.4 and 3 micrometers, 3 and 6 micrometers, 8 and 15 micrometers, 15 and 1,000 micrometers, or another suitable range of wavelengths. The sensor 310 may also be configured to detect infrared signals within a predetermined frequency range, for example between less than 200 terahertz (THz), between 200 and 400 THz, 100 and 200 THz, 35 and 100 THz, 20 and 35 THz, 0.5 and 20 THz, or another suitable range of frequencies.

In other embodiments, the sensor 310 includes an aspirating smoke detector configured to identify the characteristics of smoke or a gas that is produced (e.g., offgassed, etc.) when components in a monitored area are above a standard operating temperature conditions. In other embodiments, the sensor 310 includes an optical sensor that detects light (e.g., light produced by a fire). In yet other embodiments, the sensor 310 is capable of any combination of the afore mentioned sensing capabilities. In some embodiments, the sensor 310 is the temperature sensor 58 of FIG. 1.

The sensor 310 can sense one or more thermal characteristics (e.g., radiant heat, thermal radiation, temperature, gas emission, light, etc.) of an area or field, shown as monitored area 312. For example, the sensor 310 may be configured to sense characteristics of one or more portions of the monitored area 312 (e.g., areas, groups, zones, etc.), and communicate the sensed readings to the controller 302. The sensor 310 can provide the controller 302 with real time sensor readings. For example, the sensor 310 can provide the controller 302 with one or more signals indicating one or more real time thermal readings (e.g., radiant heat measurements, thermal radiation measurements, temperature measurements, monitored temperature values, sensed temperature values, etc.). The sensor 310 can provide the controller 302 with thermal readings relating to the monitored area 312 as a whole. In some embodiments, the sensor 310 can provide the controller 302 with thermal readings relating to one or more areas, groups, or zones that make up part and/or all of the monitored area 312. In some embodiments, the thermal readings are aggregate readings (e.g., aggregate thermal readings within the monitored area 312, within a group, area, or zone of the monitored area 312, etc.). In other embodiments, the thermal readings are discrete readings (e.g., a thermal reading relating to a discrete portion of the monitored area 312, a discrete component within the monitored area 312, etc.).

The sensor 310 can sense characteristics of a group of one or more components within the monitored area 312. For example, the sensor 310 may sense characteristics of one or more battery packs 202, or components thereof (e.g., subpack 210, battery module 220, etc.). The sensor 310 can scan the one or more battery packs 202, or components thereof, and determines thermal characteristics (e.g., radiant heat, thermal radiation, temperature, gas emissions, rate of thermal radiation change, rate of temperature change, etc.) associated with each battery pack 202, and/or the associated portion of the battery pack 202, in order to determine one or more thermal profiles.

The sensor 310 can sense characteristics of a group of one or more additional components within the monitored area 312. For example, the sensor 310 may sense thermal characteristics (e.g., radiant heat, thermal radiation, temperature, gas emissions, etc.) of one or more housings, power connectors, charging ports, power cords, cooling systems, and/or other components within one or more zones within the monitored area 312. The sensor 310 can sense thermal characteristics of components within the one or more zones, and communicates the sensed readings to the controller 302, as discussed below. The sensor 310 can be used for detection of any other suitable characteristic associated with the operation of a battery pack 202 (e.g., pressure, gas emission, fluid flow, fluid levels, power output, power input, etc.), or any combination thereof, could be incorporated in any of the functions described herein.

As shown in FIGS. 3-4, the sensor 310 can be positioned at (e.g., coupled, mounted, removably attached, etc.) an exterior portion of the monitored area 312. For example, the sensor 310 can be positioned at a central portion of the ceiling of a room (e.g., the monitored area 312). The room may be a room or area of a storage facility, and may be configured to selectively house or store one or more battery packs 202, as shown in FIGS. 3-4. In this regard, the sensor 310 may be configured to monitor the thermal characteristics (e.g., radiant heat, thermal radiation, temperature, etc.) of one or more battery packs 202 within a room of a storage facility, for example to detect and/or prevent a potential failure or thermal runaway event within the facility. In some embodiments, the sensor 310 is positioned at another portion and/or another component of the monitored area 312 (e.g., a corner, a sidewall, a rear wall, a door, etc.).

As described with reference to FIG. 3, the sensor 310 can be a high-speed infrared camera. The sensor 310 can sense real-time thermal characteristics (e.g., radiant heat, thermal radiation, temperature, gas emissions, etc.) of the monitored area 312, as a whole (e.g., T_{MA}, etc.). In this regard, the sensor 310 may be configured to measure (and/or generate) a thermal map (e.g., heat map, etc.) of the monitored area 312, as a whole. The sensor 310 may further be configured to provide the controller 302 with the real time sensor readings (e.g., T_{MA}, aggregate sensor readings, discrete sensor readings, the heat map, etc.).

In some embodiments, the sensor 310 can sense and/or identify one or more areas (e.g., groups) within the monitored area 312 (e.g., in real-time). For example, the sensor 310 may sense and/or identify thermal characteristics (e.g., radiant heat, thermal radiation, temperature, gas emissions, etc.) associated with one or more components of a battery pack 202, shown as groups 320, 322, 324, 326. For example, the sensor 310 may sense and/or identify thermal characteristics associated with one or more battery modules 220 (e.g., groups 320, 322), one or more subpacks 210 (e.g., groups 324, 326), and/or any other suitable component of the battery packs 202. The sensor 310 can sense multiple thermal characteristic within each group 320-326, and/or generate a group thermal characteristic reading for each group 320-326 (e.g., T_{G1}, T_{G2}, T_{G3}, T_{G4} . . . T_{Zn}, respectively). The group thermal readings can include the individual thermal readings, or be based on the thermal readings such as a minimum, a maximum, an average, etc. within each group 320-326. The group thermal readings may indicate a thermal characteristic of a portion or area associated with a battery pack 202, for example to facilitate detecting and/or preventing a potential failure or thermal runaway event, as discussed below.

Referring still to FIG. 3, the battery packs 202 can include one or more thermopiles (shown as the thermopiles 252, 254, 256), as discussed above. The thermopiles 252, 254, 256 can measure one or more characteristics (e.g., thermal characteristics, for example radiant heat, thermal radiation, temperature, etc.) of one or more components within the monitored area 312 (e.g., components of the battery packs 202). For example, thermopile 252 can measure a thermal characteristic at battery cells 250, thermopile 254 can measure a thermal characteristic at battery modules 220, and/or thermopile 256 can measure a thermal characteristic at subpacks 210, etc. In some embodiments, the thermopiles 252, 254, 256 can measure thermal characteristics (e.g., radiant heat, thermal radiation, temperature, gas emissions, etc.) associated with one or more components of the battery packs 202, which are indicative or representative of thermal characteristics within one or more groups (e.g., the groups 320, 322, 324, 326). For example, the thermopile 252 may measure a thermal characteristic associated with (or representative of) a battery module 220 (e.g., the group 320), thermopile 254 can measure a thermal characteristic associated with one or more battery modules 220 (e.g., groups 320, 322), and/or thermopile 256 may measure a thermal characteristic associated with one or more subpacks 210 (e.g., groups 324, 326).

The thermopiles 252, 254, 256 can communicate the sensed readings to the controller 302, as discussed below. For example, the thermopiles 252, 254, 256 may provide the controller 302 with real time thermal readings, which may indicate a thermal characteristic of one or more components of the battery packs 202 (e.g., a battery cell 250, a battery module 220, a subpack 210, etc.) and/or be representative of thermal characteristics within one or more groups (e.g., the groups 320, 322, 324, 326). The thermopiles 252, 254, 256 may provide the controller 302 with one or more signals indicating one or more real time thermal readings (e.g., radiant temperature measurements, thermal radiation measurements, temperature measurements, monitored temperature values, sensed temperature values, etc.). In some embodiments, the thermal characteristic readings are aggregate readings (e.g., aggregate thermal readings representative of a group 320, 322, 324, 326). In other embodiments, the thermal readings are discrete readings (e.g., a thermal reading relating to a battery cell 250, a battery module 220, a subpack 210, etc. within a battery pack 202). In this regard, the sensor 310 and/or the thermopiles 252, 254, 256 may be configured to measure and communicate thermal readings to the controller 302, in order to, individually or in combination, provide the controller with thermal readings to facilitate detecting a potential failure or thermal runaway event.

As described with reference to FIG. 4, the sensor 310 can be or include an infrared grid sensor. In some embodiments, the high-speed infrared camera of FIG. 3 includes the infrared grid sensor of FIG. 4. The system 300 (e.g., the controller 302, the sensor 310, etc.) may divide the monitored area 312 into one or more zones, which correspond to one or more pixels in the sensor 310. The sensor 310 may provide a real time zone thermal characteristics (e.g., average thermal readings, individual pixel thermal characteristics, for example radiant heat, thermal radiation, and/or temperature measurements, etc.) for each of the zones within the monitored area 312. In some embodiments, the sensor 310 provides a real time discrete thermal characteristics, for example relating to a discrete portion or component within a zone of the monitored area 312 (e.g., a battery pack 202 or a component thereof, a power connector, a power cord, etc.).

In some embodiments, the system 300 (e.g., the controller 302, the sensor 310) can divide (e.g., partition, split, layout, etc.) the monitored area 312 into one or more zones, shown as zones 330, 332, 334, 336, and 338 (as shown in at least FIG. 4). The sensor 310 may further be configured to individually sense a thermal characteristic within each zone 330-338. In some embodiments, the sensor 310 can sense multiple thermal characteristics within each zone 330-338, and/or generate a zone thermal reading for each zone 330-338 (e.g., T_{Z1}, T_{Z2}, T_{Z3}, T_{Z4}, T_{Z5}, . . . T_{Zn}, respectively). The zone thermal readings can include the individual thermal characteristic readings, or be based on the thermal readings such as a minimum, a maximum, an average, etc. within each zone 330-338. In some embodiments, the zones 330-338 correspond to zones or areas on the thermal reading of the monitored area 312 as a whole (e.g., the heat map).

In some embodiments, the system 300 (e.g., the controller 302) is further configured to determine (e.g., identify, match, etc.) an association between one or more thermopiles and the monitored area 312. The system 300 (e.g., the controller 302) can determine (e.g., identify) an association between thermopiles 252, 254, 265 and zones 330, 332, 334, 336, and 338. For example, the controller 302 may determine that thermopiles 252, 254 are located in zone 330, and thermopile 256 is located in zone 338. As discussed above, the controller 302 can receive thermal signals from the thermopiles 252, 254, 256, for example to determine an accuracy of a zone thermal characteristic reading (e.g., from the sensor 310), supplement a zone thermal reading (e.g., from the sensor 310), provide a discrete thermal characteristic reading of a zone, and/or otherwise provide thermal information relating to the monitored area 312.

As shown in FIGS. 3-4, the system 300 further includes one or more nozzles, shown as nozzle 342. The system 300 can include a single nozzle 342, for example positioned at or near the sensor 310 (as shown in at least FIG. 3). The nozzle 342 can selectively release a fire suppressant therefrom, for example to mitigate or prevent a potential failure or thermal runaway event.

In some embodiments, each of the zones 330-338 include a nozzle 342 (as shown in at least FIG. 4). In some embodiments, the system 300 is similarly divided (e.g., partitioned, split, laid out, etc.) into multiple individually controllable sections (portions, pieces, areas, etc.). The nozzles 342 can be individually controlled to release a fire suppressant therefrom. For example, the nozzles 342 in a zone can be selectively controlled, such that the nozzles 342 in one zone 330-338, for example 330, can be activated while the nozzles 342 in zone 332 can remain deactivated. In some embodiments, multiple sections can be activated at or near the same time, or in sequence in response to the same condition (e.g., a potential failure or thermal runaway event). In some embodiments, each section of the system 300 includes the nozzles 342 associated with an individual zone 330-338. Advantageously, the system 300 can be used as an early detection system to detect a potential failure or thermal runaway event before it occurs based on signals from the sensor 310, and notify a user to prevent a runaway event before the event actually starts.

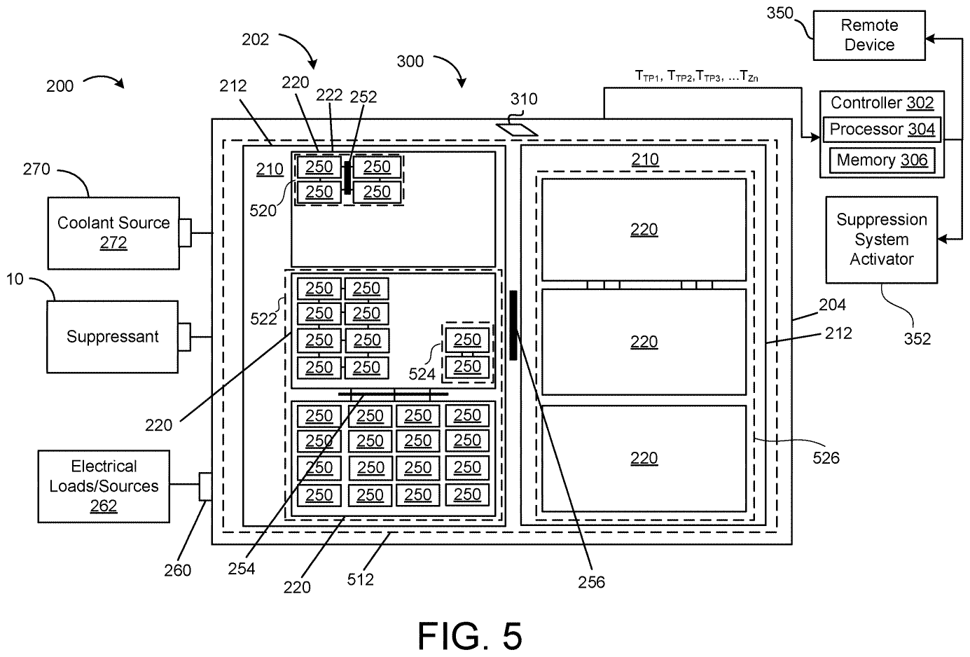

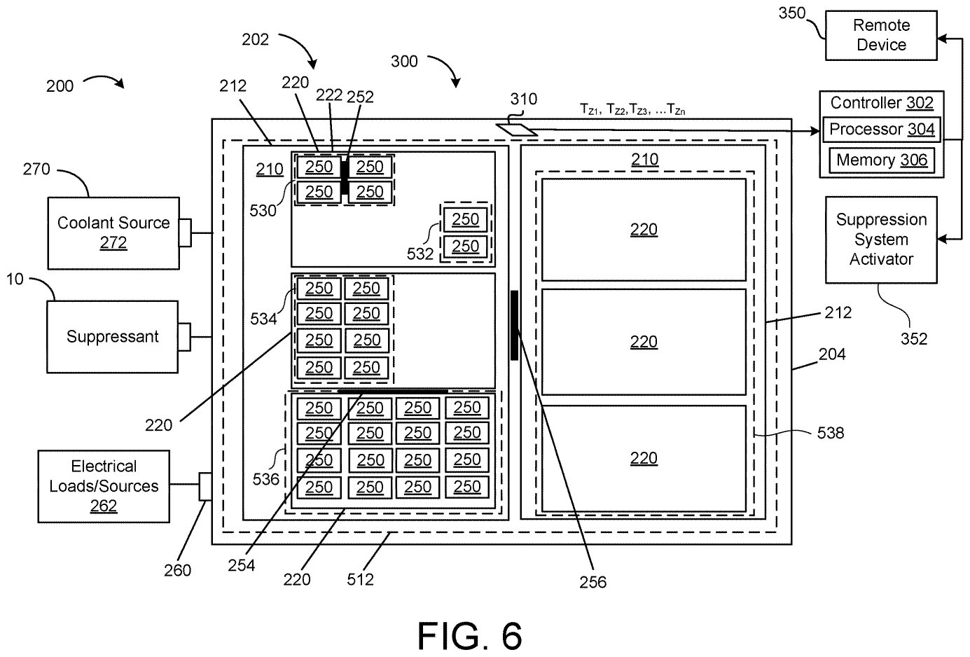

As shown in FIGS. 5-6, the sensor 310 may be positioned at (e.g., coupled, mounted, removably attached, etc.) an interior portion of the battery pack 202. For example, the sensor 310 may be positioned at (e.g., coupled with) a central portion of a top wall of the pack housing 204. The sensor 310 may be positioned at an exterior portion of a monitored area 512. For example, the sensor 310 may be positioned at an exterior portion of the pack housing 204 (e.g., the monitored area 512), as shown in FIGS. 5-6. The sensor 310 may be configured to monitor the thermal characteristics of one or more components within the pack housing 204 (e.g., a subpack 210, a battery module 220, a battery cell 250, etc.), for example to detect and/or prevent a potential failure or thermal runaway event within the battery pack 202. In some embodiments, the sensor 310 is positioned at another portion and/or component of the battery pack 202 (e.g., a corner, a sidewall, a rear wall, an inlet, an outlet, a subpack, a battery module, etc.).

The battery pack 202 can include one or more thermopiles (shown as the thermopiles 252, 254, 256), as discussed above. The thermopiles 252, 254, 256 can measure one or more characteristics (e.g., thermal characteristics, for example radiant heat, thermal radiation, temperature, etc.) of one or more components within the monitored area 512 (e.g., one or more components within the pack housing 204). For example, thermopile 252 can measure a thermal characteristic at battery cells 250, thermopile 254 can measure a thermal characteristic at battery modules 220, and/or thermopile 256 can measure a thermal characteristic at subpacks 210, etc. In some embodiments, the thermopiles 252, 254, 256 can measure thermal characteristics associated with a single component of the battery pack 202 (e.g., a battery cell 250, battery module 220, subpack 210, etc.). In other embodiments, the thermopiles 252, 254, 256 can measure thermal characteristics (e.g., radiant heat, thermal radiation, temperature, gas emissions, etc.) associated with one or more components of the battery packs 202, which may be indicative or representative of thermal characteristics within one or more groups (e.g., a group 520, 522, 524, etc., as shown in at least FIG. 5). For example, thermopile 252 can measure a thermal characteristic associated with a group of battery cells 250 (e.g., group 520), thermopile 254 can measure a thermal characteristic associated with one or more battery modules 220 (e.g., group 522), and/or thermopile 256 can measure a thermal characteristic associated with a subpack 210 (e.g., group 524).

The thermopiles 252, 254, 256 can communicate the sensed readings to the controller 302. For example, the thermopiles 252, 254, 256 can measure and provide the controller 302 with real time thermal characteristic readings, which may indicate a thermal characteristic (e.g., radiant heat, thermal radiation, temperature, etc.) of one or more components of the battery packs 202 (e.g., a battery cell 250, a battery module 220, a subpack 210, etc.). The thermopiles 252, 254, 256 can generate and can provide the controller 302 thermal reading for each thermopile 252-256 (e.g., T_{TP1}, T_{TP2}, T_{TP3}, . . . T_{Zn}, respectively). As noted above, the thermal characteristic readings can include the individual thermal readings, or be based on the thermal readings such as a minimum, a maximum, an average, etc. within each thermopile 252-256.

As described with reference to FIG. 6, the sensor 310 can be an infrared grid sensor. In other embodiments, the sensor 310 is a high-speed infrared camera. The sensor 310 can sense real-time thermal characteristics of the monitored area 512, as a whole (e.g., T_{MA}, etc.). In this regard, the sensor 310 may be configured to measure (and/or generate) a heat map of the monitored area 512, as a whole. The sensor 310 may further be configured to provide the controller 302 with the real time sensor readings (e.g., T_{MA}, aggregate sensor readings, discrete sensor readings, the heat map, etc.).

The system 300 (e.g., the controller 302, the sensor 310, etc.) may divide the monitored area 512 into one or more zones, which correspond to one or more pixels in the sensor 310. For example, the system 300 (e.g., the controller 302, the sensor 310) may be configured to divide (e.g., partition, split, layout, etc.) the monitored area 512 into one or more zones, shown as zones 530, 532, 534, 536, and 538 (as shown in at least FIG. 6). The sensor 310 may further be configured to individually sense a thermal characteristic within each zone 530-538. In some embodiments, the sensor 310 can sense multiple thermal characteristics within each zone 530-538, and/or generate a zone thermal characteristic reading for each zone 530-538 (e.g., T_{Z1}, T_{Z2}, T_{Z3}, T_{Z4}, T_{Z5}, . . . T_{Zn}, respectively). The zone thermal readings can include the individual thermal readings, or be based on the thermal readings such as a minimum, a maximum, an average, etc. within each zone 530-538. In some embodiments, the zones 530-538 correspond to zones or areas on the thermal reading of the monitored area 512 as a whole (e.g., the heat map). The sensor 310 may further be configured to provide (e.g., to the controller 302) a real time zone thermal characteristic (e.g., average thermal radiation measurement, individual pixel radiant heat measurement, etc.) for each of the zones within the monitored area 512. In some embodiments, the sensor 310 provides a real time discrete thermal readings, for example relating to a discrete portion or component within a zone of the monitored area 512 (e.g., a subpack 210 or a component thereof, a power connector, a cooling channel, an output connector, etc.).

In some embodiments, the system 300 (e.g., the controller 302) may be configured to determine (e.g., identify, match, etc.) an association between one or more thermopiles and the monitored area 512. The system 300 (e.g., the controller 302) can determine (e.g., identify) an association between thermopiles 252, 254, 265 and zones 530-538. For example, the controller 302 may determine that thermopile 252 is located in zone 330, thermopile 254 is located in zone 536, and thermopile 256 is located adjacent (e.g., proximate, abutting, etc.) zone 538. As discussed above, the controller 302 can receive thermal signals from the thermopiles 252, 254, 256, for example to determine an accuracy of a zone temperature reading (e.g., from the sensor 310), supplement a zone thermal reading (e.g., from the sensor 310), provide a discrete thermal reading of a zone, and/or otherwise provide thermal characteristic information relating to the monitored area 512.

As depicted in FIGS. 5-6, the system 300 further includes one or more suppression components configured to selectively release a fire suppressant therefore, for example to mitigate or prevent a potential failure or thermal runaway event. As shown in FIGS. 5-6, and as discussed above, the battery system 200 can include the system 10, which includes a container of a suppressant and an actuator configured to initiate a transfer (e.g., a flow) of fire suppressant from the suppressant container to the battery pack 202. In some embodiments, the system 10 can provide suppressant to an outlet (e.g., nozzle), that is positioned to direct the suppressant to an exterior of the pack housing 204. In other embodiments, the system 10 can include an outlet that can transfer a suppressant to an interior of the battery pack 202 (e.g., inside the pack housing 204, inside the housing 212, inside the housing 222, etc.), for example to mitigate or prevent a potential failure or thermal runaway event.

As shown in FIGS. 3-6, only a single sensor 310 is used in the system 300. However, it should be understood that in other embodiments, more than one sensor 310 may be used (e.g., two, three, four, etc.). Further, as shown in FIGS. 2, 3, and 5, thermopiles 252, 254, 256 are shown used in the system 300. However, it should be understood that in other embodiments, more than three thermopiles may be used (e.g., 10, 25, 50, 75, 100), which may be otherwise positioned and/or arranged (e.g., uniformly, equally spaced, staggered, etc. around the battery packs 202). The sensor 310 and/or the thermopiles 252, 254, 256 can wirelessly communicate with the controller 302 to provide controller 302 with the real time sensor readings (e.g., thermal characteristics, thermal signals, for example relating to radiant heat characteristics, thermal radiation characteristics, temperature characteristics, etc.). In other embodiments, sensor 310 and/or the thermopiles 252, 254, 256 is/are wiredly and communicably connected to controller 302 (e.g., via a wire). In some embodiments, the wire is cladded (e.g., coated, surrounded, enclosed within, etc.) with a thermally resistive material, for example to prevent the wire from being damaged due to high temperatures which the wire is exposed to.

Referring still to FIGS. 3-6, and as discussed above, the system 300 can generate one or more temperature profiles of a monitored area (e.g., the monitored area 312, 512), for example to detect and/or prevent a potential failure or thermal runaway event. The sensor 310 can sense (e.g., measure) thermal characteristics associated with a monitored area (e.g., the monitored area 312, 512), and communicate the sensed readings to the controller 302 (e.g., wirelessly, via wired connections, etc.). The thermopiles 252-256 can sense (e.g., measure) thermal characteristics associated with one or more components in a monitored area (e.g., a component of a battery pack 202 in the monitored area 312, 512), and communicate the sensed readings to the controller 302. Using the sensed readings, the controller 302 may generate an area thermal profile for the monitored area (e.g., monitored areas 312, 512), for example an area thermal profile of the monitored area as a whole. In some embodiments, the controller 302 is further configured to generate additional thermal profiles. For example, the controller 302 may be configured to generate thermopile profiles, which may represent measured thermal characteristics at a thermopile (e.g., thermopiles 252-256). In some embodiments, the controller can generate thermopile profiles, which can include measured thermal characteristics at a thermopile and one or more associated (e.g., adjacent or associated with a common component) thermopiles (e.g., thermopile profiles for thermopiles 252-256 and/or one or more associated thermopiles). In other embodiments, the controller 302 can generate zone thermal profiles (e.g., thermal profiles for zones 330-338, 530-538, etc.), and/or group thermal profiles (e.g., thermal profiles for groups 320-326, 520-524, etc.). Each thermal profile can include individual thermal characteristic readings, and/or be based on the thermal readings such as a minimum, a maximum, an average, etc.

The controller 302 can determine whether a potential failure or runaway event exists. For example, the controller 302 may determine a potential failure or thermal runaway event exists when one or more thermal profiles (e.g., area thermal profile, thermopile profile, zone thermal profile, etc., and associated thermal characteristics) exceed one or more threshold thermal conditions. A threshold thermal condition can be a maximum measured thermal radiation (e.g., at a thermopile, within a zone, etc.); a maximum deviation in measured thermal radiation or radiant heat (e.g., at a thermopile, within a zone, etc.); a maximum measured temperature (e.g., via an individual pixel, at a thermopile, within zone, etc.); a maximum average temperature across one or more thermal profiles (e.g., pixels, thermopile profiles, zone profiles, a monitored area, etc.); a threshold number of thermal profiles (or components therein) exceed a certain thermal characteristic (e.g., pixels, thermopiles, zones, etc.); a rate of increase of one or more thermal characteristics exceeds a threshold (e.g., at a pixel, a thermopile, a zone, a monitored area, etc.); etc., or any combination thereof. The controller 302 may determine a potential failure or runaway event is present when one or more of the threshold thermal conditions is satisfied (e.g., based on the readings from the sensor 310, the thermopiles 252-256, a combination thereof, etc.). In some embodiments, the controller 302 determines a potential failure or runaway event is present when a certain percentage, or predetermined value, of the threshold thermal condition is satisfied (e.g., based on the readings from the sensor 310, the thermopiles 252-256, etc.).

Upon determining a potential failure or runaway event is present, the controller 302 may implement one or more control decisions. For example, the controller 302 can be configured to communicate an indicator to a device (e.g., a personal computer, a user device, an emergency device, a server, a mobile device, a distributed computing system, etc.), shown as remote device 350. In an embodiment, the controller 302 can communicate an indicator (e.g., alert, alarm, message, warning message) to the remote device 350, indicating a potential failure or runaway event has been detected. In some embodiments, the controller 302 can communicate an indicator (e.g., instructions, message, diagrams, etc.) to the remote device 350, providing instructions for how to address the potential failure or runaway event. In other embodiments, the controller 302 can communicate an indicator (e.g., follow-up message, follow-up instructions, etc.) to the remote device 350, including a follow-up notification that a potential failure or runaway event is no longer present. In some embodiments, the controller 302 can populate one or more interfaces at the remote device 350. The interfaces may include an indication or indicator (e.g., alarm, message, instruction, etc.) that includes any suitable information relating to a potential failure or runaway event.

In some embodiments, the control decisions (e.g., communication of an alert, alarm, message, etc.) include additional information relating to the specific potential failure or runaway event that has been detected. For example, the controller 302 may determine a first potential failure is present (e.g., based on a first thermopile reading exceeding a first threshold) and communicate a first message (e.g., a warning of an elevated thermal characteristic at the first thermopile); determine a second potential failure is present (e.g., based on a second thermopile reading exceeding a second threshold) and communicate a second message (e.g., instructions to initiate a response action to prevent thermal runaway at the second thermopile); determine a third potential failure is present (e.g., based on a first zone reading exceeding a third threshold) and communicate a third message (e.g., a warning of an elevated thermal characteristic at the first zone); determine a fourth potential failure is present (e.g., based on a second zone reading exceeding a fourth threshold) and communicate a fourth message (e.g., instructions to initiate a response action to prevent thermal runaway at the second zone); etc. In this regard, the controller 302 may be configured to implement various control decisions, which may include communicating alerts, alarms, or instructions specific to the detected potential failure or thermal runaway event.

In some embodiments, upon determining a potential failure or runaway event is present, the controller 302 is further configured to communicate a control decision (e.g., signal) to activate one or more components of the system 10. For example, the controller 302 may be configured to communicate a control decision (e.g., activation signal, response signal, control signal, etc.) to a suppression system activator 352. In an embodiment, the suppression system activator 352 can receive the control decision from the controller 302, and activate one or more components of the system 10 (e.g., actuator 30). For example, the suppression system activator 352 may be configured to activate the system 10 (e.g., actuator 30) such that fire suppressing agent flows out of the fire suppressant tank 12, through pipe 40, and exits nozzles 42, 342 to extinguish a failure or thermal runaway event in the monitored area (e.g., monitored area 312, 512).

As discussed above, in some embodiments the system 10 is divided into one or more sections (e.g., zones, as shown in at least FIG. 4). According to an embodiment, upon determining a potential failure or runaway event is present, the controller 302 can communicate a control signal to activate select nozzles (e.g., nozzles 42, 342) in select sections of the monitored area 312. For example, controller 302 can detect a potential failure or runaway event in a zone 330 based on thermal readings (e.g., zone thermal readings) from the sensor 310 and/or the thermopiles 252-256 (e.g., thermopile thermal characteristic readings indicating a thermal characteristic of one or more components of a battery pack 202). The controller 302 may communicate a control decision to the suppression system activator 352, which causes the suppression system activator 352 to activate system 10 (e.g., actuator 30) to release fire suppressant from the fire suppressant section associated with zone 330, including from all nozzles 342 in zone 330. In an embodiment, the control decision causes the suppression system activator 352 to withhold (e.g., restrict, restrain, etc.) releasing fire suppressant from nozzles 342 in the remaining zones 332-338.

In some embodiment, the controller 302 can detect multiple potential failures or thermal runaway events, and provide multiple control decisions to the remote device 350 (e.g., alarms, alerts, messages, instructions, etc.) and/or the suppression system activator 352 (e.g., activation signals, control signals, etc.). In some embodiments, the multiple control decisions are provided at different times; however, in other embodiments the multiple control signals are provide at or near the same time. In some embodiments, the controller 302 can monitor an area, group, or zone of a first potential failure or runaway event (e.g., via the sensor 310) after a first control decision is communicated to the remote device 350 and/or the suppression system activator 352. In other embodiments, the controller 302 can communicate a second control decision (e.g., subsequent, follow-up, etc.) based on the monitoring of the area, group, or zone of the first potential failure or runaway event.

For example, the controller 302 may communicate a first control decision (e.g., an alert) to the remote device 350 providing a warning of a potential failure or thermal runaway event at a first thermopile (e.g., thermopile 252). After sending the first control decision, the controller 302 may monitor the area, group, and/or zone associated with the first thermopile (e.g., thermopile 252), for example via thermal readings from the sensor 310 and/or the thermopile 252. If the thermal characteristic at the first thermopile (e.g., thermopile 252) drops below a threshold (e.g., a first threshold, threshold thermal condition, predetermined threshold, etc.) such that a potential failure or thermal runaway event is no longer detected, the controller 302 may communicate a second control decision (e.g., follow-up message, etc.) indicating that the potential failure or thermal runaway is no longer detected. In this regard, when the controller 302 no longer detects a potential failure or thermal runaway event (e.g., at thermopiles 252-256, in zones 330-338, 530-538, etc.), the controller 302 can communicate a second control signal to the remote device 350 (e.g., a follow-up message, etc.) and/or the suppression system activator 352 (e.g., a deactivation signal, a stop signal, etc.). In an embodiment, the controller 302 no longer detects a potential failure or thermal runaway event when the threshold thermal condition is no longer satisfied; however, in other embodiments the controller 302 no longer detects a potential failure or thermal runaway event when the thermal characteristic at an area, group, zone, or monitored area and/or component is below a predetermined threshold (e.g., certain value, reduced percentage of threshold thermal condition, etc.). In other embodiments, the controller 302 can deactivate the system 10 in response to a command from a user, for example received from the remote device 350.

In other embodiments, the controller 302 is further configured to perform one or more safety actions, in addition or alternatively to communicating a control decision to the remote device 350 and/or the suppression system activator 352. In some embodiments, the controller 302 can shut off a gas valve (e.g., to a zone of and/or the monitored area), flip a breaker associated with a zone and/or the monitored area, etc. It should be understood that the controller 302 may perform multiple safety actions at once, or over a period of time, for example in response to detecting a potential failure or thermal runaway event.

### Controller Diagram

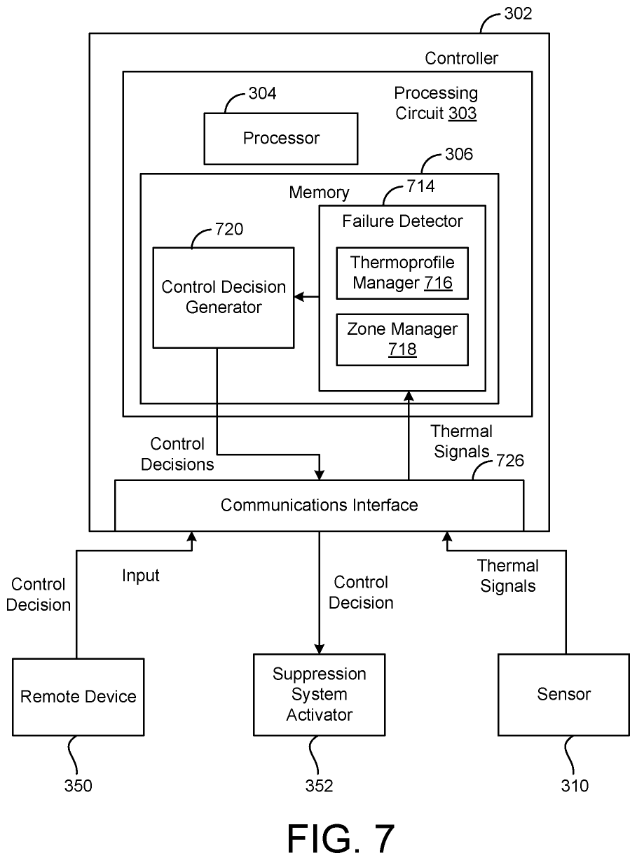

Referring now to FIG. 7, the controller 302 is shown in greater detail, according to an embodiment. In some embodiments, the controller 302 can receive any of the real time thermal readings (e.g., thermal characteristic data) from the sensor 310 and/or thermopiles 252-256, for example to determine if a potential failure or thermal runaway event has occurred, or is likely to occur. In some embodiments, the controller 302 can receive thermal readings from the sensor 310 and/or thermopiles 252-256 over a learning time period to determine one or more characteristics of the monitored area 312, 512, as discussed below. In some embodiments, the controller 302 can receive characteristics relating to the monitored area 312, 512 (e.g., layouts, predetermined thresholds, threshold values, threshold thermal conditions, etc.) from a user or operator, for example via the remote device 350.

As shown in FIG. 7, the controller 302 includes a communications interface 726, according to some embodiments. The communications interface 726 may facilitate communications between the controller 302 and one or more external devices or applications. For example, the communications interface 726 may communicate with the sensor 310, in order to facilitate communication of any user control, monitoring, adjustment, etc., to any of the sensor 310, the suppression system activator 208, and/or any other device, system, sensor, inputs, outputs, etc., described herein. In an embodiment, the communications interface 726 can communicate with the thermopiles 252-256, for example to facilitate communication of thermal characteristic measurements (e.g., radiant heat, thermal radiation, temperature measurements, etc.). The communications interface 726 may also facilitate communications between the controller 302 and a remote device, server, or system, for example the remote device 350. In some embodiments, the communications interface 726 facilitates communications between the controller 302 and one or more external devices (e.g., a remote server, a remote device, a removable data storage device, etc.).

The communications interface 726 can be or include wired or wireless communications interfaces (e.g., jacks, antennas, transmitters, receivers, transceivers, wire terminals, etc.) for conducting data communications with any of the sensor 310, the thermopiles 252-256, the suppression system activator 352, the remote device 350, or other external systems or devices. In various embodiments, communications via the communications interface 726 can be direct (e.g., local wired or wireless communications) or via a communications network (e.g., a WAN, the Internet, a cellular network, etc.). For example, the communications interface 726 can include an Ethernet card and port for sending and receiving data via an Ethernet-based communications link or network. In another example, the communications interface 726 can include a Wi-Fi transceiver for communicating via a wireless communications network. In another example, the communications interface 726 can include cellular or mobile phone communications transceivers.

Still referring to FIG. 7, the controller 302 is shown to include a processing circuit 303 including the processor 304 and the memory 306, according to some embodiments. The processing circuit 303 can be communicably connected to the communications interface 726 such that processing circuit 303 and the various components thereof (e.g., the processor 304, the memory 306, etc.) can send and receive data via the communications interface 726. The processor 304 can be implemented as a general purpose processor, an application specific integrated circuit (ASIC), one or more field programmable gate arrays (FPGAs), a group of processing components, or other suitable electronic processing components.

The memory 306 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. The memory 306 can be or include volatile memory or non-volatile memory. The memory 306 can include database components, object code components, script components, or any other type of information structure for supporting the various activities and information structures described in the present application. According to some embodiments, the memory 306 is communicably connected to the processor 304 via the processing circuit 303 and includes computer code for executing (e.g., by the processing circuit 303 and/or the processor 304) one or more processes described herein.

Referring still to FIG. 7, the memory 306 is shown to include a failure detector 714. According to an embodiment, the failure detector 714 can receive one or more signals and/or data (e.g., thermal signals, thermal data), for example from the sensor 310 and/or the thermopiles 252-256 (e.g., via the communications interface 726). The failure detector 714 may further be configured to determine in a potential failure or thermal runaway event, a fault, or hazardous condition (e.g., fire, likely fire, etc.) exists based on the thermal signals. In some embodiments, the failure detector 714 can determine if a failure or thermal runaway event is impending, is likely to occur, and/or exists, for example based on whether one or more threshold thermal conditions exists. For example, the failure detector 714 may determine a failure or thermal runaway event is present if a threshold thermal condition exists (e.g., maximum radiant heat or thermal radiation, average radiant heat or thermal radiation conditions above a threshold, etc.), as discussed above. In some embodiments, the failure detector 714 determines a potential failure or thermal runaway event is present when a certain percentage (e.g., 50, 60, 75, 80, 85, 90, 95, etc. percent), or predetermined value, of the threshold thermal condition is satisfied.

As noted above, the threshold thermal condition can be a maximum measured thermal radiation (e.g., at a thermopile, within a zone, etc.); a maximum deviation in measured thermal radiation or radiant heat (e.g., at a thermopile, within a zone, etc.); a maximum measured temperature (e.g., via an individual pixel, at a thermopile, within zone, etc.); a maximum average temperature across one or more thermal profiles (e.g., pixels, thermopile profiles, zone profiles, a monitored area, etc.); a threshold number of thermal profiles (or components therein) exceed a certain thermal characteristic (e.g., pixels, thermopiles, zones, etc.); a rate of increase of one or more thermal characteristics exceeds a threshold (e.g., at a pixel, a thermopile, a zone, a monitored area, etc.); etc., or any combination thereof. The controller 302 may determine a potential failure or runaway event is present when one or more of the threshold thermal conditions is satisfied (e.g., based on the readings from the sensor 310, the thermopiles 252-256, etc.). The threshold thermal conditions can be a threshold thermal value, a threshold average thermal value over a period of time, an unusual sequence of thermal values, thermal values persistently above an average temperature value, etc. In some embodiments, the failure detector 714 receives the threshold thermal conditions from a user, operator, service provide, device manufacturer, service provider, etc., for example via the remote device 350 (e.g., via the communications interface 726).

In some embodiments, the failure detector 714 learns the threshold thermal conditions over a learning period (e.g., based on the thermal signals, thermal data, etc. received via the sensor 310, the thermopiles 252-256, etc.). In some embodiments, the threshold thermal condition is based on a learned characteristic. For example, in response to a detected potential failure or thermal runaway event, the failure detector 714 may be configured to generate and save a threshold condition profile (e.g., based on and/or including the thermal signals received from the sensor 310 and/or thermopiles 252-256 during the detected potential failure). In an embodiment, the failure detector 714 can determine whether a subsequent potential failure or thermal runaway event is present based on a comparison of the real time thermal signals (e.g., from the sensor 310 and/or thermopiles 252-256) and the thermal signals of the threshold condition profile. In some embodiments, a subsequent potential failure is determined to be present based on the real time thermal signals exceeding the thermal signals of the threshold condition profile. In other embodiments, a subsequent potential failure is determined to be present based on the real time thermal signals exceeding the thermal signals of a profile provided (e.g., via the remote device 350) or hardcoded into the controller 302. If a potential failure or thermal runaway event is detected during the subsequent event, a second threshold condition profile can be generated and saved. In this regard, the failure detector 714 may be configured to generate and/or save a plurality of threshold condition profiles over time (e.g., a learning period), which can be used to evaluate subsequent events for potential failures and/or provide additional threshold condition profiles.

As shown in FIG. 7, the failure detector 714 includes a thermoprofile manager 716. In an embodiment, the thermoprofile manager 716 can associate one or more signals or data (e.g., thermal signals, thermal data), for example from the thermopiles 252-256, with one or more thermopiles in a monitored area. For example, the thermoprofile manager 716 may be configured to receive and/or associate one or more thermal signals from/with one or more thermopiles 252-256 in the monitored area 312 and/or the monitored area 512. The thermal signals may be indicative of a thermal characteristic at the thermopiles 252-256 (e.g., radiated heat, thermal radiation, infrared thermal radiation, a temperature gradient, etc.), which may indicate thermal characteristic information relating to one or more components within the monitored areas 312, 512 (e.g., a battery cell 250, a battery module 220, a subpack 210, a battery pack 202 as a whole, etc.).

In some embodiments, the thermoprofile manager 716 is also configured to identify one or more thermopiles in the monitored areas 312, 512, which may be used to determine one or more thermal profiles indicative and/or representative of components in the monitored areas 312, 512. For example, the thermoprofile manager 716 may identify one or more thermopiles within the monitored areas 312, 512, for example based on user input (e.g., component configurations, component layouts, etc.), hardcoded rules or layouts, learned thermal readings or configuration data, one or more inputs, including monitored area layout, component configurations, etc. In some embodiments, the thermoprofile manager 716 can determine (e.g., identify, etc.) one or more associations between the one or more thermopiles in the monitored areas 312, 512. For example, the thermoprofile manager 716 may determine a spacing (e.g., uniform, non-uniform, staggered, etc.), a component association, a thermopile magnitude, etc., between the thermopiles (and/or one or more other components) in the monitored areas 312, 512. In this regard, the thermoprofile manager 716 may be configured to determine a layout (e.g., configuration, map, profile, etc.) of the one or more thermopiles in the monitored areas 312, 512, which may be used to analyze thermal readings from one or more of the thermopiles (e.g., a select group, all of the thermopiles, etc.) to detect a potential failure or thermal runaway event.

In other embodiments, the thermoprofile manager 716 is further configured to divide the monitored areas 312, 512 into one or more groups. For example, the thermoprofile manager 716 may be configured to divide the monitored areas 312, 512 into one or more groups that include one or more thermopiles (e.g., thermopile 252 in groups 320, 520; thermopile 254 in groups 322, 522; thermopile 256 in groups 324, 326, 524; etc.). In this regard, the thermoprofile manager 716 may be configured to associate the one or more groups (e.g., groups 320-326, groups 520-526, etc.) with the one or more thermopiles (e.g., thermopiles 252-256), which may indicate and/or represent temperature characteristics of one or more components in the monitored areas 312, 512 (e.g., battery cells 250, battery modules 220, subpacks 210, etc.). In some embodiments, the thermoprofile manager 716 further divides the monitored areas 312, 512 based on a layout of the monitored area 312, 512, a location of the thermopile, and/or the components associated with the thermopile (e.g., a battery cell 250, a battery module 220, a subpack 210, a battery pack 202, etc.). In other embodiments, the thermoprofile manager 716 identifies the thermopiles (e.g., thermopiles 252-256) based on one or more prior thermal readings at a thermopile, an existing thermal profile associated with a thermopile, and/or additional thermal or other configuration information.

In some embodiments, the thermoprofile manager 716 can receive thermal signals from one or more thermopiles (e.g., thermopiles 252-256) over a learning period. The learning period may allow the thermoprofile manager 716 to determine characteristic and/or archetypal conditions for the monitored areas 312, 512 (including the one or more thermopiles therein). For example, in some embodiments, one thermopile may be associated with a battery cell 250 proximate to a top wall of a battery pack 202 and/or a charging port of the battery pack 202. In some embodiments, the learning period facilitates the thermoprofile manager 716 learning configuration thermal characteristics (e.g., charging) for the battery pack 202 and/or thermopile. For example, the learning period may facilitate learning specific maximum thermal radiation or radiant heat, maximum temperatures, and/or other configuration thermal characteristics (e.g., non-charging, discharging, etc.) related to the battery pack 202 (e.g., the thermopile). Further, the learning period may facilitate learning an average time, or acceptable peak thermal characteristics (e.g., radiant heat, thermal radiation, temperature, etc.), for a thermopile. In an embodiment, learning configuration or application specific thermal characteristics, or other configurations related data, facilitates the thermoprofile manager 716 developing a layout of the thermopiles 252-256 (e.g., within a battery module 220, a subpack 210, a battery pack 202, the monitored area 312, 512, etc.), which provide thermal profiles that are indicative of characteristic (e.g., usual), average, and/or unusual conditions of a battery pack 202. Further, the learning period may facilitate the thermoprofile manager 716 determining if one or more characteristics relating to thermopiles 252-256 are characteristic (e.g., usual), average, or unusual, for example to minimize inadvertent (e.g., erroneous, etc.) detection of a potential failure or thermal runaway event.

In some embodiments, the thermoprofile manager 716 continuously monitors the thermal signals of the monitored areas 312, 512, and adjusts the thermopiles (e.g., thermopiles 252-256) used in measuring one or more thermal profiles (e.g., a thermal profile of a battery pack 202, etc.), for example based on the changes in the thermal signals (e.g., from the thermopiles 252-256). For example, the thermoprofile manager 716 may receive thermal signals of the monitored area 312 (e.g., thermopile 252) indicating that a battery pack 202 is leaking and is taking longer to charge than typical (e.g., via consistent and/or increased thermal radiation readings at thermopile 252). The thermoprofile manager 716 may recognize that the battery pack 202 has a charging issue, and identify different and/or adjust the layout of thermopiles 252-256 (e.g., to replace previous thermopile 252, identify thermopiles more representative of the thermal profile of the battery pack 202 as a whole). For example, the thermoprofile manager 716 may identify a new set of thermopiles 252-256 within the battery pack 202 (e.g., a new thermopile 252), which account for the thermal radiation increase at the charging port, and a thermal radiation decrease at the battery or power leak. In other embodiments, the thermoprofile manager 716 may adjust the layout of the identified thermopiles (e.g., thermopiles 252-256) used in measuring a thermal profile (e.g., a thermal profile of a battery pack 202) based on one or more configurations or characteristics, for example charging/non-charging configurations, time, date, thermal characteristics of surrounding areas, etc.

In some embodiments, the thermoprofile manager 716 receives information to identify one or more thermopiles 252-256, via user input (e.g., via the remote device 350). For example, a user can provide a layout of the monitored area 312, 512, a position of one or more battery packs 202 and/or components thereof, the thermal profile for one or more battery packs 202, etc., and the thermoprofile manager 716 can use the information to identify and/or determine a configuration (e.g., layout, spacing, type, etc.) of the one or more thermopiles 252-256.

In an embodiment, the failure detector 714 (e.g., via the thermoprofile manager 716) can detect a potential failure or thermal runaway event at one or more of the thermopiles. For example, the failure detector 714 (e.g., via the thermoprofile manager 716) may determine a potential failure or runaway event exists at one or more of the thermopiles (e.g., thermopiles 252-256) when one or more threshold thermal conditions is satisfied at the thermopiles (e.g., thermopiles 252-256). The failure detector 714 may communicate information relating to the detected potential failure or runaway event to a control decision generator, which may communicate one or more control decisions to an external device or application (e.g., remote device 350, suppression system activator 352, etc.), as discussed below.

As shown in FIG. 7, the failure detector 714 also includes a zone manager 718. In an embodiment, the zone manager 718 can associate one or more signals or data (e.g., thermal signals, thermal data), for example from the sensor 310, with one or more zones in a monitored area. For example, the zone manager 718 may be configured to receive and/or associate one or more thermal signals from/with one or more zones 330-338 in monitored area 312 and/or one or more zones 530-538 in monitored area 512. In an embodiment, the zone manager 718 is also configured to associate one or more thermal signals with one or more components within the zones 330-338, zones 530-538. The temperature signals may be indicative of a thermal characteristic of the zones 330-338, 530-538 (e.g., radiated heat, thermal radiation, infrared thermal radiation, a temperature gradient, etc.), which may indicate thermal information relating to one or more components within the monitored areas 312, 512 (e.g., a battery cell 250, a battery module 220, a subpack 210, etc.).

In some embodiments, the zone manager 718 is also configured to create or divide the zones within the monitored areas 312, 512, which may be used to determine one or more thermal profiles in the monitored areas 312, 512. For example, the zone manager 718 may divide the monitored areas 312, 512 into one or more zones (e.g., zones 330-338, zones 530-538, respectively) based on a layout of the monitored area 312, 512, a location and type of component within the monitored area 312, 512 (e.g., a battery pack 202, a location of the battery pack 202, a battery cell 250, a type and configuration of the battery cell 250, etc.), and/or the application or uses of one or more components within the monitored area 312, 512 (e.g., storage of a battery pack 202, charging of a battery pack 202, charging of a battery cell, etc.). In some embodiments, the zone manager 718 can divide the zones (e.g., zones 330-338, zones 530-538) based on a location of one or more nozzles in the monitored area 312, 512, one or more prior thermal characteristic measurements of components in the monitored area 312, 512, and/or any other suitable information relating to the monitored areas 312, 512 and/or components therein.

In some embodiments, the zone manager 718 divides the zones within the monitored areas 312, 512 based on thermal signals (e.g., received from the sensor 310, the thermopiles 252-256, etc.) over a learning period. The learning period may allow the zone manager 718 to determine characteristic and/or archetypal conditions for the monitored areas 312, 512, including one or more components (e.g., a battery pack 202, a battery cell 250) contained therein. For example, in some embodiments the monitored area 312 includes a battery pack 202, which may be placed in the monitored area 312 for storage, charging, and/or discharging. In some embodiments, the learning period facilitates the zone manager 718 learning thermal conditions of various configurations (e.g. charging, etc.) for the battery pack 202. For example, the learning period may facilitate learning specific maximum thermal characteristic (e.g., radiant heat or thermal radiation, maximum temperatures, and/or other configuration temperatures for non-charging, or discharging, etc.) related to the battery pack 202 and/or the surrounding components. Further, the learning period may facilitate learning an average time, or acceptable peak thermal conditions, for the battery pack 202 and/or components therein (e.g., a battery cell 250, etc.). In an embodiment, learning configuration or application specific thermal conditions, or other configuration related data, facilitates the zone manager 718 automatically developing a layout of the zones (e.g., zones 330-338, zones 530-538), which provide thermal profiles that are indicative of characteristic (e.g., usual), average, and/or unusual conditions of the monitored area 312, 512 and/or components therein (e.g., a battery pack 202, a battery cell 250, etc.). Further, the learning period may facilitate the zone manager 718 determining if one or more characteristics relating to the zones (e.g., zones 330-338, zones 530-538) are characteristic (e.g., usual), average, or unusual, for example to minimize inadvertent (e.g., erroneous, etc.) detection of a potential failure or thermal runaway event.

In some embodiments, the zone manager 718 continuously monitors the thermal signals of the monitored areas 312, 512, and adjusts the zones (e.g., zones 330-338, zones 530-538) based on the changes in the thermal signals (e.g., from the sensor 310, the thermopiles 252,-256, etc.). For example, the zone manager 718 may receive thermal signals of the monitored area 312 (e.g., zone 330) indicating that a battery pack 202 has been removed from the zone 330, or removed from storage (e.g., via a consistent and/or decreased temperature readings in zone 330). The zone manager 718 may recognize that the battery pack 202 has been removed from the zone 330, and adjust the layout of the zones 330-338. For example, the zone manager 718 may reassign maximum allowable thermal conditions (e.g., maximum thermal radiation measured, maximum temperature conditions, etc.) from zones 332-338 to zone 330. In other embodiments, the zone manager 718 may adjust the layout of the zones (e.g., zones 330-338, zones 530-538) based on one or more configurations or characteristics, for example charging/non-charging configurations, time, date, thermal characteristics of surrounding areas, etc.

In other embodiments, the zone manager 718 receives information to identify and/or divide one or more zones (e.g., zones 330-338, zones 530-538) via user input (e.g., via the remote device 350). For example, a user can provide a layout of the monitored area 312, 512, a position of one or more battery packs 202 and/or components thereof (e.g., battery cells 250, battery modules 220, subpacks 210, etc.), the thermal profile for one or more battery packs 202, etc., and the zone manager 718 can use the information to identify and/or create the one or more zones (e.g., zones 330-338, zones 530-538) within the monitored area 312, 512.

In an embodiment, the failure detector 714 (e.g., via the zone manager 718) can detect a potential failure or thermal runaway event at one or more of the zones identified and/or generated by the zone manager 718. For example, the failure detector 714 (e.g., via the zone manager 718) may determine a potential failure or runaway event exists at one or more of the zones (e.g., zones 330-338, zones 530-538) when one or more threshold thermal conditions is satisfied at the zones (e.g., zones 330-338, zones 530-538). The failure detector 714 may communicate information relating to the detected potential failure or thermal runaway event to a control decision generator, which may communicate one or more control decisions to an external device or application (e.g., remote device 350, suppression system activator 352, etc.), as discussed below.

In some embodiments, the failure detector 714 (e.g., via the zone manager 718, the thermoprofile manager 716, etc.) can perform additional identification, verification, and/or confirmation functions relating to a potential failure or thermal runaway event. For example, in some embodiments the failure detector 714 (e.g., via the zone manager 718) can detect a potential failure or thermal runaway event at a zone identified and/or generated by the zone manager 718 (e.g., zone 330, 530, etc.). In response to detecting a potential failure or thermal runaway event at a zone (e.g., zone 330, 530, etc.), the failure detector 714 may further be configured to identify (e.g., via the thermoprofile manager 716) one or more thermopiles (e.g., thermopile 252) within the identified zone (e.g., zone 330, 530). The failure detector 714 may further be configured to receive thermal signals (e.g., via the thermoprofile manager 716) from the one or more thermopiles (e.g., thermopile 252) within the identified zone. In an embodiment, the thermal signals from the thermopile (e.g., thermopile 252) are compared to a threshold condition, for example to determine (e.g., confirm, deny, etc.) whether a potential failure or thermal runaway event has been detected at the thermopile (e.g., thermopile 252) and within the zone (e.g., zone 330, 530). In some embodiments, the failure detector 714 (e.g., the thermoprofile manager 716) can receive thermal signals from a plurality of thermopiles within the identified zone (e.g., zone 330, 530), which may be compared to a threshold condition to determine whether a potential thermal runaway event exists at a specific thermopile. In this regard, the failure detector 714 (e.g., via the thermoprofile manager 716) may be configured to receive thermal signals from a plurality of thermopiles, for example to isolate a discrete component that may experience a potential failure or thermal runaway event. In yet other embodiments, the failure detector 714 can receive thermal signals (e.g., from the sensor 310, the thermopiles 252-256, etc.), and the thermoprofile manager 716 and/or the zone manager 718 can perform other diagnostic, detection, and/or confirmation functions, individually or in any proper combination.

As shown in FIG. 7, the memory 306 also includes a control decision generator 720. The control decision generator 720 may be configured to receive information relating to a detected potential failure or thermal runaway event (e.g., from the failure detector 714). This may include information relating to a thermopile (e.g., thermopiles 252-256) and/or a zone (e.g., zones 330-338, zones 530-538) associated with the detected potential failure or runaway event. The information may also include the specific conditions (e.g., component configuration, temperature readings, etc.) associated with the potential failure or runaway event.

In an embodiment, the control decision generator 720 can generate one or more control decisions based on the information relating to the potential failure or thermal runaway event, and/or communicate the control decisions to the remote device 350, the suppression system activator 352, and/or another device or system. In some embodiments, the control decision generator 720 can determine an appropriate control decision (e.g., based on the information relating to the potential failure or thermal runaway event). As noted above, the control decision can include communicating an indicator (e.g., alert, alarm, message, instruction, follow-up message, update, etc.), communicating a control signal (e.g., activation signal, response signal, deactivation signal, etc.), initiating an automated action (e.g., automatically implementing a safety measure, etc.), and/or any combination thereof. The control decision generator 720 can be configured to generate and/or communicate a plurality of control decisions, for example in sequence or at the same time. In some embodiments, the control decision generator 720 can generate and/or communicate control decisions in real time, for example to allow the remote device 350 to monitor real time thermal information, performance data, and/or event, alarm, and/or alert data.

It should also be understood that while the controller 302 is described herein as receiving thermal readings from the sensor 310 and/or the thermopiles 252-256, the controller 302 may also be communicably connected to the remote device 350 and/or receive real time readings or data (e.g., thermal readings) from the remote device 350. It should also be understood that in some embodiments, the characteristic values, threshold thermal conditions, thermal readings, etc. can be communicated to a remote database, remote server, for example for storage. It should also be understood that although a single learning period is discussed herein, in some embodiments the learning period may be re-performed to re-determine the characteristics for a specific application. In some embodiments, multiple learning periods can be performed, and the characteristic values for each learning period can be stored locally in controller 302 (e.g., the failure detector 714) and/or on the remote device 350. In some embodiments, the sensor 310 and/or the remote device 350 can perform any and/or all of the operations described herein, for example the operations or functions of the controller 302.

### Processes for Implementing Thermal Runaway Detection and Alert System

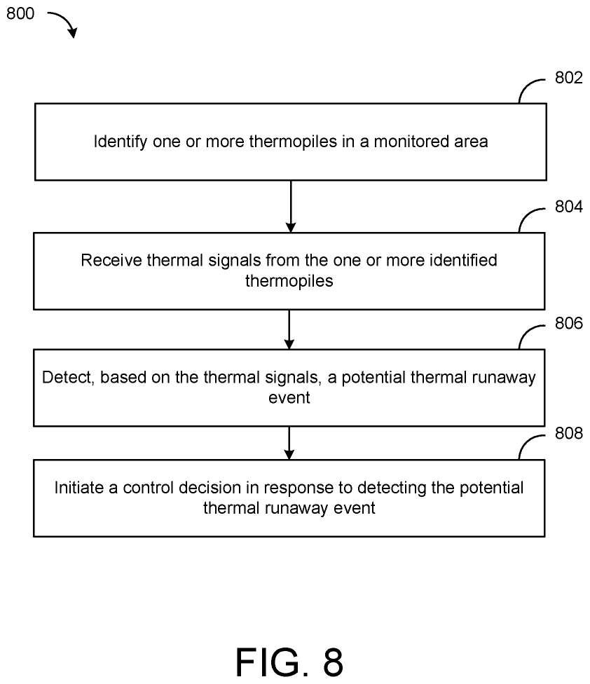

Referring now to FIG. 8, a process 800 for operating a fire detection, prevention, mitigation, and/or suppression system is shown, according to some embodiments. In an embodiment, process 800 is performed by one or more of the systems described above, for example system 10 and/or system 300. In some embodiments, process 800 is performed by a controller (e.g., the controller 302), and/or any various components of controller of the fire detection and suppression system.

Process 800 is shown to include identifying one or more thermopiles in a monitored area (step 802), according to an embodiment. The one or more thermopiles (e.g., thermopiles 252-256) may be associated with one or more components of a battery pack (e.g., battery pack 202, subpack 210, battery module 220, battery cell 250), or another suitable component within a monitored area. In an embodiment, the one or more thermopiles are identified, for example based on user input (e.g., a component configuration, component layout, etc.), hardcoded rules or layouts, etc. In some embodiments, the one or more thermopiles are identified via a controller or components thereof (e.g., thermoprofile manager 716 of controller 302). In some embodiments, the one or more thermopiles are identified based on thermal signals or data associated with a thermopile (e.g., received from the thermopiles 252-256). For example, the thermopiles may be identified based on thermal signals over a learning period. In some embodiments, the thermopiles are identified based on a layout of the monitored area (e.g., connections within the monitored area 312, 512, hardcoded rules, etc.), components within the monitored areas, and/or user input (e.g., via the remote device 350). In some embodiments, the thermopiles are identified in response to receiving a command, selection, etc., for example a command provided by a user or operator (e.g., via the remote device 350).

Process 800 includes receiving thermal signals from the one or more thermopiles (step 804), according to some embodiments. In an embodiment, the thermal signals indicate thermal characteristics, respectively, at the one or more thermopiles (e.g., thermopiles 252-256). The thermal measurements (e.g., characteristics) may include measurements relating to radiated heat, thermal radiation, infrared thermal radiation, a temperature gradient, a current temperature, or any other suitable thermal measurement. In some embodiments, the thermal signal is received at one or more components of a controller (e.g., the controller 302, thermoprofile manager 716, etc.). In some embodiments, the monitored area is the monitored area 312. In other embodiments, the monitored area is the monitored area 512.

In some embodiments, process 800 includes generating thermal profiles of the thermal signals of the monitored area. In an embodiment, a controller or components thereof (e.g., the controller 302) can generate a thermal profile representing the thermal characteristics (e.g., from the thermal signal) of one or more components (e.g., via the association with the thermal signal) of the monitored area. In some embodiments, the process 800 includes generating a plurality of thermal profiles, for example a plurality of thermopile profiles (e.g., thermal profiles of measurements at thermopiles 252-256), and/or a thermal profile of the monitored area as a whole (e.g., monitored area 312, 512).

Process 800 includes detecting, based on the thermal signals, a potential thermal runaway event (step 806), according to some embodiments. In some embodiments, the potential thermal runaway event is or includes a potential failure, fault, or hazardous condition (e.g., a fire, likely fire, etc.). In other embodiments, the potential thermal runaway event is an event at the one or more thermopiles (e.g., thermopiles 252-256). According to an embodiment, a controller or components thereof (e.g., the controller 302, the failure detector 714) can detect a potential thermal runaway event, for example by comparing the thermal signals to threshold thermal conditions. In some embodiments, the threshold thermal condition is a maximum measured thermal radiation (e.g., of an individual component, thermopile, etc.), a maximum deviation in measured thermal radiation or radiant heat, a maximum measured temperature, a maximum average temperature across one or more components (e.g., at one or thermopiles, etc.), a rate of temperature increase of the component (e.g., thermopile), a threshold number of components exceed a certain thermal characteristic, and/or any other suitable threshold temperature measurement.

Process 800 includes initiating a control decision in response to detecting a potential thermal runaway event (step 808), according to some embodiments. In an embodiment, a controller or components thereof (e.g., the controller 302) can generate one or more control decisions in response to detecting a potential thermal runaway event. Initiating a control decision may include communicating a control decision to a remote device (e.g., the remote device 350), for example communicating an indicator (e.g., alert, alarm, message, instruction, follow-up message, update, etc.) relating to the potential thermal runaway event. In other embodiments, initiating a control decision includes communicating a control decision to a system or activator (e.g., system 10, suppression system activator), for example communicating a control signal (e.g., activation signal, response signal, deactivation signal, etc.) to initiate one or more actions to respond or address the potential thermal runaway event. In other embodiments, initiating a control decision includes initiating an automated action (e.g., automatically implementing a safety measure, etc.), and/or any combination thereof.

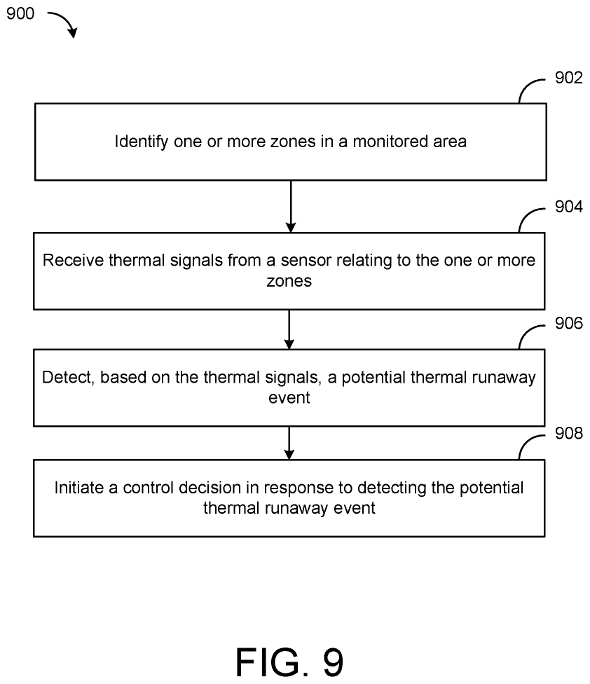

Referring now to FIG. 9, a process 900 for operating a fire detection, prevention, mitigation, and/or suppression system is shown, according to some embodiments. In an embodiment, process 900 is performed by one or more of the systems described above, for example system 10 and/or system 300. In some embodiments, process 900 is performed by a controller (e.g., the controller 302), and/or any various components of controller of the fire detection and suppression system.

Process 900 is shown to include identifying one or more zones in a monitored area (step 902), according to an embodiment. The one or more zones (e.g., zones 330-338, zones 530-538) may include one or more components (e.g., battery pack 202, nozzles 342, battery cells 250, etc.) within the monitored area (e.g., monitored area 312, 512). The one or more zones may be identified via a controller or components thereof (e.g., zone manager 718 of controller 302). In some embodiments, the one or more zones are identified based on thermal signals or data (e.g., received from the sensor 310, the thermopiles 252-256, etc.). For example, the zones may be identified based on thermal signals over a learning period. In some embodiments, the zones are identified based on a layout of the monitored area (e.g., monitored area 312, 512, etc.), components within the monitored areas, and/or user input (e.g., via the remote device 350). In other embodiments, a controller or components thereof (e.g., the controller 302, zone manager 718) can create or divide the monitored area (e.g., monitored area 312, 512) into one or more zones (e.g., zones 330-338, zones 530-538, respectively). In some embodiments, the zones are identified in response to receiving a command, selection, etc., for example a command provided by a user or operator (e.g., via the remote device 350).

Process 900 includes receiving thermal signals from a sensor for the one or more identified zones (step 904), according to some embodiments. In some embodiments, process 900 also includes receiving thermal signals from one or more thermopiles, for example the thermopiles 252-256. In an embodiment, the thermal signals indicate thermal characteristics, respectively, at the one or more zones (e.g., zones 330-338, zones 530-538). In some embodiments, the sensor is sensor 310 (e.g., a high-speed infrared camera, a grid sensor, etc.). In some embodiments, the thermal signal is received at one or more components of a controller (e.g., the controller 302, zone manager 718, etc.). In some embodiments, the monitored area is the monitored area 312. In other embodiments, the monitored area is the monitored area 512.

In some embodiments, process 900 includes generating thermal profiles of the thermal signals of the monitored area. In an embodiment, a controller or components thereof (e.g., the controller 302) can generate a thermal profile representing the thermal characteristics (e.g., from the thermal signal) of one or more components (e.g., via the association with the thermal signal) of the monitored area. In some embodiments, the process 900 includes generating a plurality of thermal profiles, for example a plurality of zone thermal profiles (e.g., thermal profiles of the zones 330-338, zones 530-538), a plurality of thermopile profiles (e.g., profiles of the measured thermal characteristics at thermopiles 252-256), and/or a thermal profile of the monitored area as a whole (e.g., monitored area 312, 512).

Process 900 includes detecting, based on the thermal signals, a potential thermal runaway event (step 906), according to some embodiments. In some embodiments, the potential thermal runaway event is or includes a potential failure, fault, or hazardous condition (e.g., a fire, likely fire, etc.). In other embodiments, the potential thermal runaway event is an event at the one or more zone (e.g., zones 330-338, zones 530-538). According to an embodiment, a controller or components thereof (e.g., the controller 302, the failure detector 714) can detect a potential thermal runaway event, for example by comparing the thermal signals to threshold thermal conditions. In some embodiments, the threshold thermal condition is a maximum measured thermal radiation (e.g., of an individual zone, or component thereof, e.g., a battery pack, battery cell, etc.), a maximum deviation in measured thermal radiation, a maximum measured temperature, a maximum average of the thermal characteristic across one or more zones or components thereof (e.g., zones 330-338, zones 530-538, etc.), a rate of increase of a thermal characteristic within the zone or a component thereof (e.g., an individual zone, or a component thereof, e.g., a battery pack, battery cell, etc.), a threshold number of components exceed a certain thermal characteristic threshold, and/or any other suitable threshold thermal characteristic measurement, as discussed above.

Process 900 includes initiating a control decision in response to detecting a potential thermal runaway event (step 908), according to some embodiments. In an embodiment, a controller or components thereof (e.g., the controller 302) can generate one or more control decisions in response to detecting a potential thermal runaway event. Initiating a control decision may include communicating a control decision to a remote device (e.g., the remote device 350), for example communicating an indicator (e.g., alert, alarm, message, instruction, follow-up message, update, etc.) relating to the potential thermal runaway event. In other embodiments, initiating a control decision includes communicating a control decision to a system or activator (e.g., system 10, suppression system activator), for example communicating a control signal (e.g., activation signal, response signal, deactivation signal, etc.) to initiate one or more actions to respond or address the potential thermal runaway event. In other embodiments, initiating a control decision includes initiating an automated action (e.g., automatically implementing a safety measure, etc.), and/or any combination thereof.

### Configuration of Embodiments

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, and/or illustrations of possible embodiments (and such terms are not intended to connote that such embodiments are necessarily extraordinary or superlative examples).

The term “coupled,” as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. Such members may be coupled mechanically, electrically, and/or fluidly.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below,” etc.) are merely used to describe the orientation of various elements in the FIGURES. It should be noted that the orientation of various elements may differ according to other embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the fire suppression system as shown in the various embodiments is illustrative only. Although only a few embodiments have been described in detail in this disclosure, many modifications are possible (e.g., variations in sizes, dimensions, structures, shapes and positions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. Other substitutions, modifications, changes, and omissions may be made in the design, operating conditions and arrangement of the embodiments without departing from the scope of the present disclosure.

Additionally, any element disclosed in one embodiment may be incorporated or utilized with any other embodiment disclosed herein. For example, the system 300 of the embodiment described in at least FIGS. 3-7 may be incorporated in the system 10 of the embodiment described in at least FIG. 1. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A thermal runaway detection and prevention system, comprising:
one or more thermopiles configured to measure one or more thermal characteristics of a monitored area; and
a controller having one or more processors and a memory storing instruction that, when executed by the one or more processors, cause the one or more processors to perform operations comprising:
identifying the one or more thermopiles in the monitored area;
receiving, from the one or more thermopiles, thermal signals relating to one or more measured thermal characteristics of the monitored area;
detecting, based on the thermal signals, a potential thermal runaway event; and
initiating a control decision in response to detecting the potential thermal runaway event.

2. The system of claim 1, wherein the monitored area includes a plurality of battery cells positioned within a battery module.

3. The system of claim 1, wherein the monitored area includes a plurality of battery modules positioned within a battery subpack.

4. The system of claim 1, wherein the monitored area includes a plurality of battery subpacks positioned within a battery pack.

5. The system of claim 1, wherein the one or more measured thermal characteristics relates to at least one of a radiant heat associated with the monitored area, a thermal radiation associated with the monitored area, or a temperature associated with the monitored area.

6. The system of claim 1, wherein the thermal signals are received from the one or more thermopiles in real time.

7. The system of claim 1, wherein detecting the potential thermal runaway event includes determining an average of the one or more measured thermal characteristics over a period of time exceeds a predetermined threshold average of the one or more thermal characteristics over the period of time.

8. The system of claim 1, wherein detecting the potential thermal runaway event includes determining a predetermined number of the one or more measured thermal characteristics exceeds a predetermined threshold of the thermal characteristic.

9. The system of claim 1, wherein detecting the potential thermal runaway event includes determining a rate of change of the one or more measured thermal characteristics over a period of time exceeds a predetermined threshold rage of change for the one or more thermal characteristics over the period of time.

10. The system of claim 1, wherein initiating the control decision includes at least one of activating a nozzle associated with the monitored area to deliver a fire suppressant agent to at least one component of the monitored area, or providing an indication to a computing device, the indication including a warning message and an instruction to mitigate the potential thermal runaway event.

11. A thermal runaway detection and prevention system, comprising:
an infrared sensor configured to measure one or more thermal characteristics of a monitored area; and
a controller having one or more processors and a memory storing instruction that, when executed by the one or more processors, cause the one or more processors to perform operations comprising:
identifying one or more zones in the monitored area;
receiving, from the infrared sensor, thermal signals relating to one or more measured thermal characteristics, wherein the one or more measured thermal characteristics relate to one or more identified zones;
detecting, based on the thermal signals, a potential thermal runaway event; and
initiating a control decision in response to detecting the potential thermal runaway event.

12. The system of claim 11, wherein the infrared sensor can measure the one or more thermal characteristics within a predefined frequency range.

13. The system of claim 11, wherein the monitored area includes a plurality of battery cells positioned within a battery module.

14. The system of claim 11, wherein the monitored area includes a battery pack positioned within a storage facility.

15. The system of claim 11, wherein the one or more measured thermal characteristics relates to at least one of a radiant heat associated with the monitored area, a thermal radiation associated with the monitored area, or a temperature associated with the monitored area.

16. The system of claim 11, wherein the thermal signals are received from the infrared sensor in real time.

17. A method for detecting and mitigating a potential thermal runaway event, comprising:
identifying, via a controller, one or more thermopiles in a monitored area;
receiving, from the one or more thermopiles in the monitored area, thermal signals relating to one or more measured thermal characteristics of the monitored area;
detecting, via the controller and based on the thermal signals, the potential thermal runaway event; and
initiating, via the controller, a control decision in response to detecting the potential thermal runaway event.

18. The method of claim 17, wherein detecting the potential thermal runaway event includes determining an average of the one or more measured thermal characteristics over a period of time exceeds a predetermined threshold average of the one or more thermal characteristics over the period of time.

19. The method of claim 17, wherein detecting the potential thermal runaway event includes determining a predetermined number of the one or more measured thermal characteristics exceeds a predetermined threshold of the thermal characteristic.

20. The method of claim 17, wherein initiating the control decision includes at least one of activating a nozzle associated with the monitored area to deliver a fire suppressant agent to at least one component of the monitored area, or providing an indication to a computing device, the indication including a warning message and an instruction to mitigate the potential thermal runaway event.
